(19) United States
(12) Patent Application Publication
(10) Pub. No.: US 2026/0180751 A1
(43) Pub. Date: Jun. 25, 2026

(54) DEMODULATION REFERENCE SIGNAL PATTERN CONFIGURATIONS

(71) Applicant: QUALCOMM Incorporated, San Diego, CA (US)

(72) Inventors: Somsubhra BARIK, San Diego, CA (US); Jing SUN, San Diego, CA (US)

(21) Appl. No.: 18/999,750

(22) Filed: Dec. 23, 2024

(51) Int. Cl. H04L 5/00

(52) U.S. Cl. CPC H04L 5/0051; H04L 5/0092

(57) ABSTRACT

Various aspects of the present disclosure generally relate to wireless communication. In some aspects, a user equipment (UE) may receive configuration information indicating, for a demodulation reference signal (DMRS), a time domain spacing parameter and a time domain offset parameter. The UE may receive a start and length indicator value (SLIV) indicating a time domain resource allocation associated with a channel. The UE may communicate, during the time domain resource allocation, one or more DMRSs associated with the channel at one or more respective time domain locations that are based at least in part on the SLIV, the time domain spacing, and the time domain offset. Numerous other aspects are described.

### FIELD OF THE DISCLOSURE

Aspects of the present disclosure generally relate to wireless communication and specifically relate to techniques, apparatuses, and methods associated with demodulation reference signal pattern configurations.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A demodulation reference signal (DMRS) may carry information used to estimate a radio channel for demodulation of an associated physical channel. The design and mapping of a DMRS may be specific to a physical channel for which the DMRS is used for estimation. DMRSs are user equipment specific, can be beamformed, and can be confined in a scheduled resource (e.g., rather than transmitted on a wideband). DMRSs may be used for both downlink communications and uplink communications.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example wireless communication network, in accordance with the present disclosure.

FIGS. 4A through 6C are diagrams illustrating example demodulation reference signal configurations, in accordance with the present disclosure.

FIG. 7 is a diagram illustrating an example process performed, for example, at a user equipment (UE) or an apparatus of a UE, in accordance with the present disclosure.

FIG. 8 is a diagram illustrating an example process performed, for example, at a network node or an apparatus of a network node, in accordance with the present disclosure.

FIGS. 9 and 10 are diagrams of example apparatuses for wireless communication, in accordance with the present disclosure.

### SUMMARY

Some aspects described herein relate to a method of wireless communication performed by a user equipment (UE). The method may include receiving configuration information indicating, for a demodulation reference signal (DMRS), a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The method may include receiving a start and length indicator value (SLIV) indicating a time domain resource allocation (TDRA) associated with a channel. The method may include communicating, during the TDRA, one or more DMRSs associated with the channel at one or more respective time domain locations that are based at least in part on the SLIV, the time domain spacing, and the first time domain offset.

Some aspects described herein relate to a method of wireless communication performed by a network node. The method may include transmitting, to a UE, configuration information indicating, for a DMRS, a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The method may include transmitting an SLIV indicating a TDRA associated with a channel. The method may include communicating, during the TDRA, one or more DMRSs associated with the channel at one or more respective time domain locations that are based at least in part on the SLIV, the time domain spacing, and the first time domain offset.

Some aspects described herein relate to an apparatus for wireless communication at a UE. The apparatus may include one or more memories and one or more processors coupled to the one or more memories. The one or more processors may be configured to receive configuration information indicating, for a DMRS, a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The one or more processors may be configured to receive an SLIV indicating a TDRA associated with a channel. The one or more processors may be configured to communicate, during the TDRA, one or more DMRSs associated with the channel at one or more respective time domain locations that are based at least in part on the SLIV, the time domain spacing, and the first time domain offset.

Some aspects described herein relate to an apparatus for wireless communication at a network node. The apparatus may include one or more memories and one or more processors coupled to the one or more memories. The one or more processors may be configured to transmit, to a UE, configuration information indicating, for a DMRS, a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The one or more processors may be configured to transmit an SLIV indicating a TDRA associated with a channel. The one or more processors may be configured to communicate, during the TDRA, one or more DMRSs associated with the channel at one or more respective time domain locations that are based at least in part on the SLIV, the time domain spacing, and the first time domain offset.

Some aspects described herein relate to a non-transitory computer-readable medium that stores a set of instructions for wireless communication by a UE. The set of instructions, when executed by one or more processors of the UE, may cause the UE to receive configuration information indicating, for a DMRS, a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The set of instructions, when executed by one or more processors of the UE, may cause the UE to receive an SLIV indicating a TDRA associated with a channel. The set of instructions, when executed by one or more processors of the UE, may cause the UE to communicate, during the TDRA, one or more DMRSs associated with the channel at one or more respective time domain locations that are based at least in part on the SLIV, the time domain spacing, and the first time domain offset.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating, for a DMRS, a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The set of instructions, when executed by one or more processors of the network node, may cause the network node to transmit an SLIV indicating a TDRA associated with a channel. The set of instructions, when executed by one or more processors of the network node, may cause the network node to communicate, during the TDRA, one or more DMRSs associated with the channel at one or more respective time domain locations that are based at least in part on the SLIV, the time domain spacing, and the first time domain offset.

Some aspects described herein relate to an apparatus for wireless communication. The apparatus may include means for receiving configuration information indicating, for a DMRS, a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The apparatus may include means for receiving an SLIV indicating a TDRA associated with a channel. The apparatus may include means for communicating, during the TDRA, one or more DMRSs associated with the channel at one or more respective time domain locations that are based at least in part on the SLIV, the time domain spacing, and the first time domain offset.

Some aspects described herein relate to an apparatus for wireless communication. The apparatus may include means for transmitting, to a UE, configuration information indicating, for a DMRS, a time domain spacing parameter and a time domain offset parameter, where the time domain offset parameter indicates a first time domain offset from a set of first candidate time domain offsets, and where the set of first candidate time domain offsets is based at least in part on a time domain spacing indicated by the time domain spacing parameter. The apparatus may include means for transmitting an SLIV indicating a TDRA associated with a channel. The apparatus may include means for communicating, during the TDRA, one or more DMRSs associated with the channel at one or more respective time domain locations that are based at least in part on the SLIV, the time domain spacing, and the first time domain offset.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the application and design constraints imposed on the overall system.

In some wireless communication networks, wireless communication devices (e.g., user equipments (UEs), network nodes) may use a demodulation reference signal (DMRS) to estimate a radio channel for demodulation of an associated physical channel. The design and mapping of a DMRS may be specific to a physical channel for which the DMRS is used for estimation. A pattern of DMRSs (or DMRS instances) may be indicated via one or more configuration parameters (e.g., radio resource control (RRC) parameters or other parameters). For example, a DMRS configuration (e.g., DMRS-downlinkConfig for downlink DMRS configuration or DMRS-uplinkConfig for uplink DMRS configuration) may indicate DMRS position(s) within a slot. As an example, the DMRS configuration may indicate a DMRS mapping type, such as a DMRS Type A and a DMRS Type B. The DMRS mapping type may be indicative of a first OFDM symbol within a slot that includes a DMRS (e.g., for DMRS mapping Type A, a first DMRS within a slot may be included in symbol 2 or symbol 3 within the slot, and for DMRS mapping Type B, the DMRS starts at the first symbol of a time domain resource allocation (TDRA) for a physical channel (e.g., indicated by a start and length indicator value (SLIV) as described elsewhere herein)).

In some cases, a DMRS pattern or configuration may be for an SLIV that is associated with indicating a TDRA that spans multiple slots or that is not limited to being contained within a single slot (e.g., sometimes referred to as a fluid SLIV). Here, a network node may indicate the DMRS configuration based on a time domain spacing parameter and a time domain offset parameter. The time domain spacing parameter may be indicative of a spacing (e.g., in the time domain) between DMRS instances within a TDRA for a physical channel (e.g., indicated by a fluid SLIV). As used herein, “DMRS instance” refers to a time domain resource in which a DMRS is communicated (e.g., transmitted and/or received). A DMRS instance may include one or more symbols (sometimes referred to as DMRS symbols) in which a DMRS is configured.

The time domain spacing parameter may indicate one or more time gaps between DMRS instances included in the TDRA. Therefore, the quantity of DMRS instances that are included in a given TDRA may be based on, or otherwise associated with, the time domain spacing parameter and a size of the given TDRA (e.g., as indicated by the SLIV which may be indicated via control information). The time domain offset parameter may indicate a time domain position of a first DMRS instance within a TDRA. For example, the time domain offset parameter may indicate an offset relative to the start of the TDRA (e.g., as indicated by the SLIV), indicative of a first symbol in which a DMRS is configured. In some examples, the quantity of symbols within the TDRA prior to the first DMRS symbol (e.g., corresponding to the time domain offset parameter) and the quantity of symbols within the TDRA after the last DMRS symbol may be associated with extrapolated channel estimations (e.g., as opposed to interpolated channel estimations). In some cases, extrapolated symbols may be associated with a lower channel estimation quality as compared to interpolated symbols. Additionally, extrapolated symbols that are spaced farther away from DMRS symbols may be associated with lower channel estimation qualities as compared to extrapolated symbols that are closer to DMRS symbols.

In some aspects, the DMRS configuration (e.g., including the time domain spacing parameter and the time domain offset parameter) may be indicated via multiple communications. For example, an RRC communication may indicate first information for the time domain spacing parameter and a control communication (e.g., downlink control information (DCI) or other control information) may indicate second information for the time domain spacing parameter. The time domain spacing parameter may be based on the first information and the second information.

To indicate the time domain spacing parameter and the time domain offset parameter for the DMRS configuration, a network node may transmit signaling that includes a first indication of the time domain spacing parameter and a second indication of the time domain offset parameter. In some cases, the first indication may indicate the time domain spacing parameter from a set of candidate time domain spacing parameters, and a quantity of bits within the first indication may be based on the quantity of candidate time domain spacing parameters in the set. Additionally, the second indication may indicate the time domain offset parameter from a set of candidate time domain offset parameters, and a quantity of bits within the second indication may be based on the quantity of candidate time domain offset parameters in the set.

Various aspects relate generally to improving an efficiency of the signaling that includes the DMRS configuration. More specifically, instead of transmitting signaling that indicates the time domain offset parameter and the time domain spacing parameter independently, a network node may instead transmit signaling that indicates the time domain spacing parameter and indicates the time domain offset parameter based on the indicated time domain spacing parameter. In some cases, the set of candidate time domain offset parameters may be based on the time domain spacing parameter indicated by the signaling. For example, the set of candidate time domain offset parameters may be limited to including candidate time domain offsets that are less than the indicated time domain spacing parameter. Limiting the set of candidate time domain offset parameters based on the indicated time domain spacing parameter may decrease the quantity of candidate time domain offset parameters in the set, which may in turn decrease a quantity of bits within an indication of the time domain offset parameter.

Particular aspects of the subject matter described in this disclosure can be implemented to realize one or more of the following potential advantages. In some examples, the described techniques can be used to improve an efficiency of signaling between devices. That is, by decreasing the quantity of bits necessary to configure a DMRS, the efficiency of the DMRS configuration signaling may be improved.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

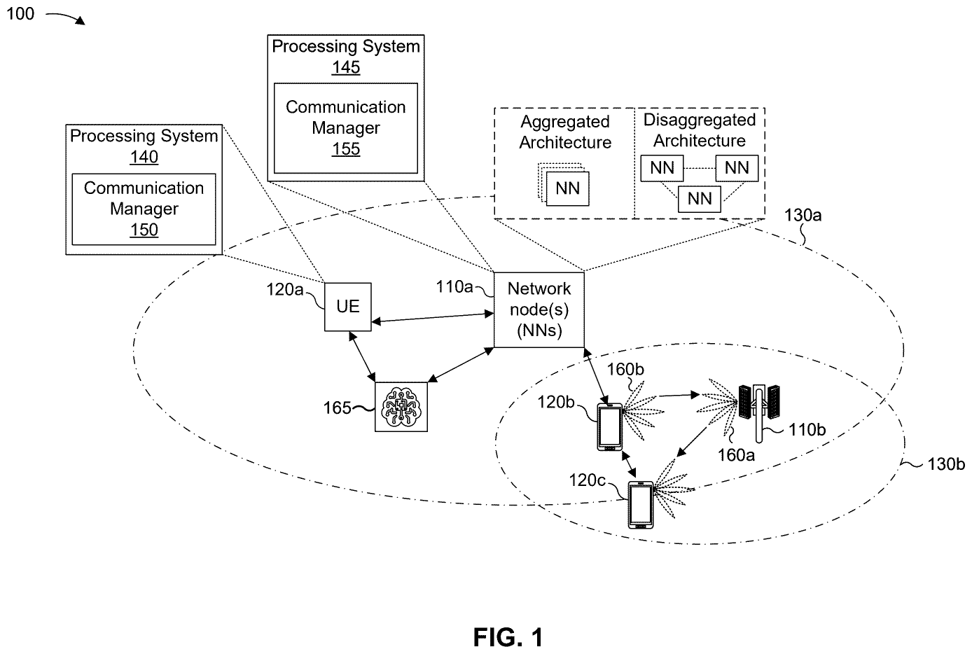

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

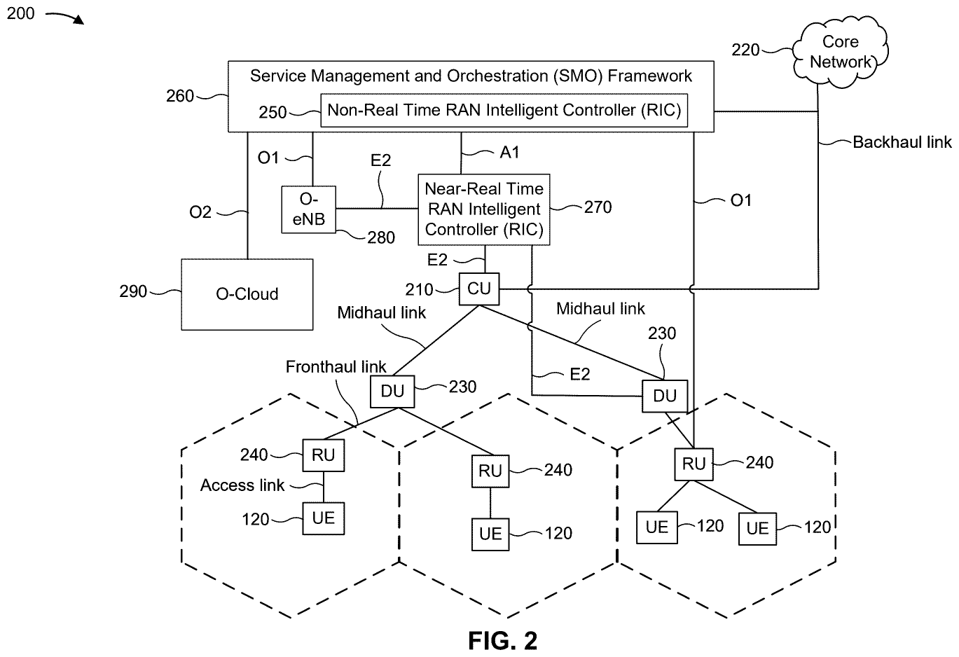

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 monitors and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an synchronization signal PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi-co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter; receive an SLIV indicating a TDRA associated with a channel; and communicate, during the TDRA, one or more DMRSs associated with the channel at one or more respective time domain locations that are based at least in part on the SLIV, the time domain spacing, and the first time domain offset. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter; transmit an SLIV indicating a TDRA associated with a channel; and communicate, during the TDRA, one or more DMRSs associated with the channel at one or more respective time domain locations that are based at least in part on the SLIV, the time domain spacing, and the first time domain offset. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

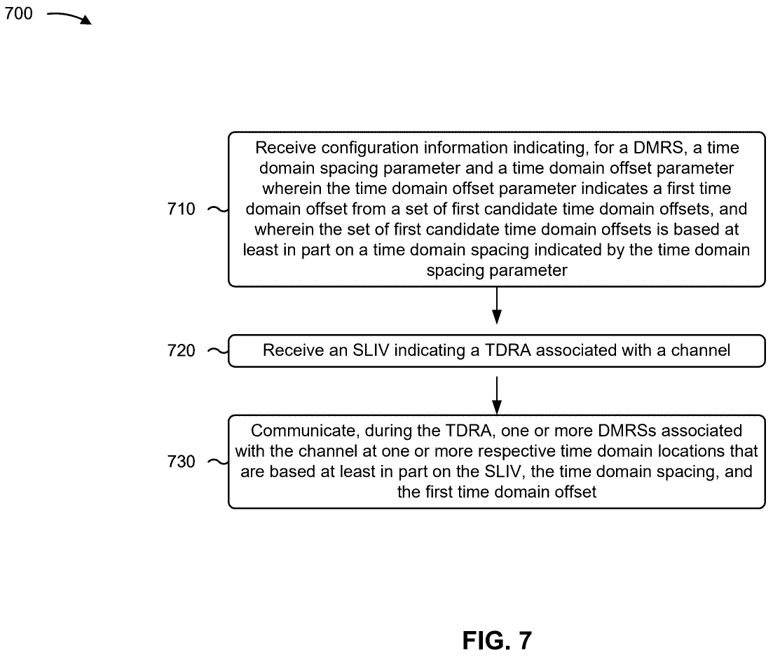

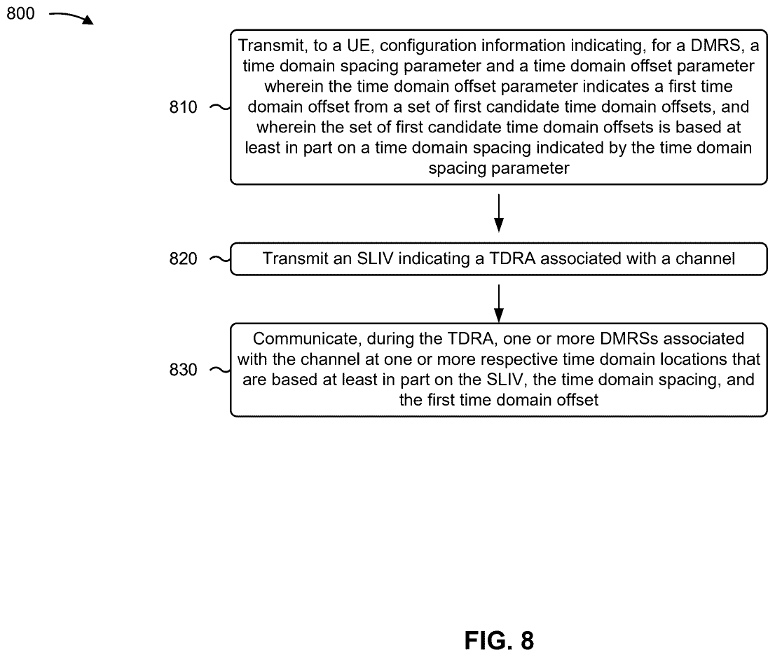

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with DMRS pattern configurations, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

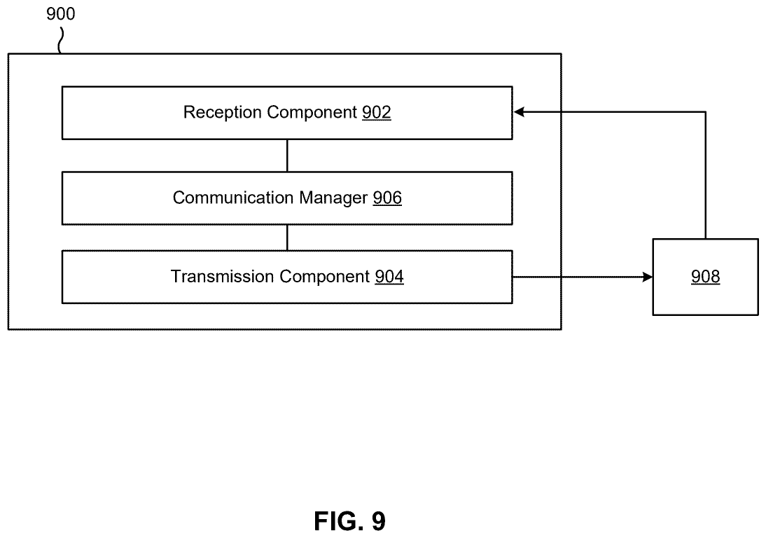

In some aspects, a UE includes means for receiving configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter; means for receiving an SLIV indicating a TDRA associated with a channel; and/or means for communicating, during the TDRA, one or more DMRSs associated with the channel at one or more respective time domain locations that are based at least in part on the SLIV, the time domain spacing, and the first time domain offset. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

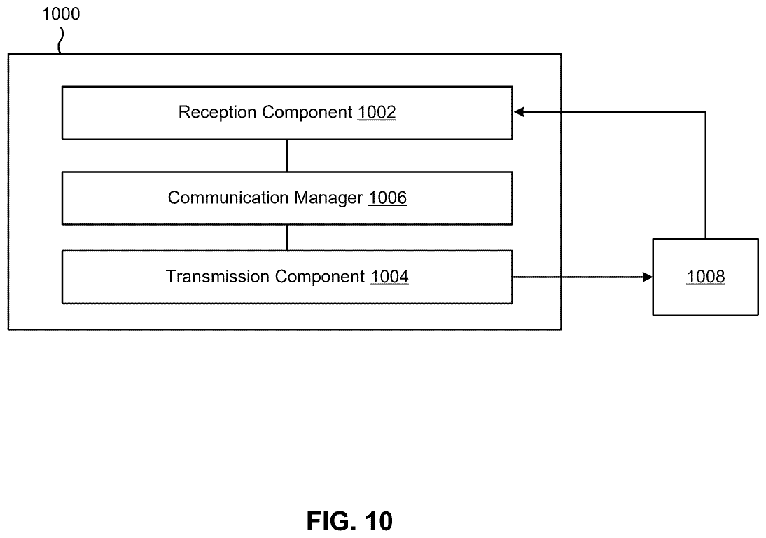

In some aspects, a network node includes means for transmitting, to a UE, configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter; means for transmitting an SLIV indicating a TDRA associated with a channel; and/or means for communicating, during the TDRA, one or more DMRSs associated with the channel at one or more respective time domain locations that are based at least in part on the SLIV, the time domain spacing, and the first time domain offset. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

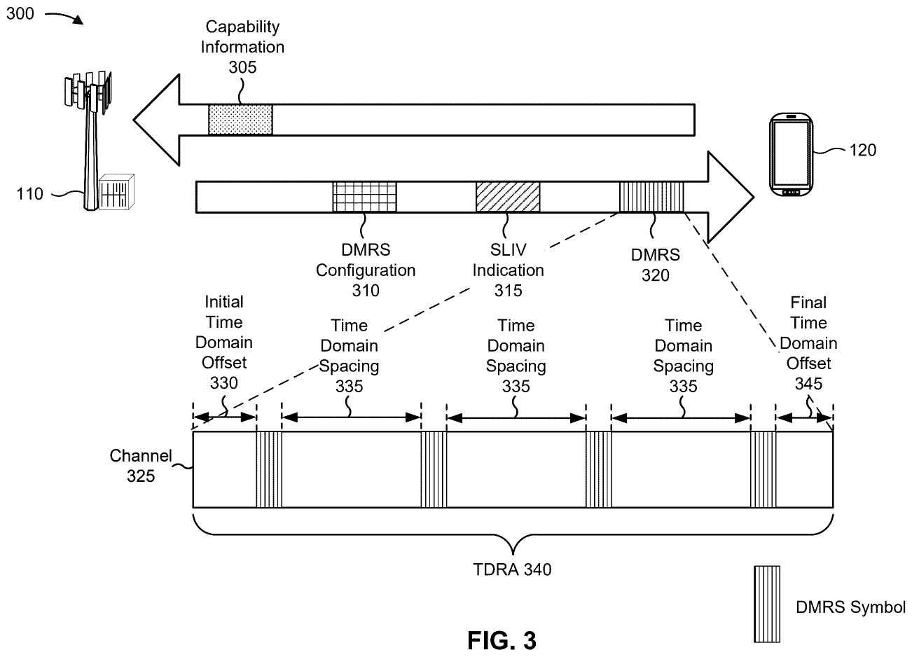

FIG. 3 is a diagram illustrating an example wireless communication network 300, in accordance with the present disclosure. As shown in FIG. 3, a network node 110 and a UE 120 may communicate with one another. In the example wireless communication network 300, the network node 110 may provide a DMRS configuration 310 to the UE 120, and the corresponding DMRS 320 may be transmitted (e.g., in the uplink, in the downlink) in accordance with the DMRS configuration 310.

The UE 120 may transmit, and the network node 110 may receive, capability information 305. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC-CE communication, an RRC communication, a PUCCH, a PUSCH, a physical sidelink control channel (PSCCH), and/or a physical sidelink shared channel (PSSCH), among other examples.

The capability information 305 may be indicative of a capability of the UE 120 related to transmitting or receiving DMRSs 320. For example, the capability information 305 may indicate supported values for the time domain spacing parameter and/or the time domain offset parameter, as described herein. Additionally, or alternatively, the capability information 305 may indicate a DMRS processing window size of the UE 120, a buffer capacity of the UE 120, a quantity of DMRS symbols that can be processed by the UE 120 during a DMRS processing window, a quantity of time domain bases that are supported by the UE 120 for channel estimation, or a time domain filtering capability of the UE 120 for DMRS-based channel estimation.

The DMRS processing window size of the UE 120 may correspond to a sliding window size or a DMRS processing window length indicating an amount of time during which the UE 120 is to store data samples and/or DMRS samples for channel estimation. The buffer capacity of the UE 120 may correspond to a size or memory capacity of a buffer of the UE 120 for storing data samples and/or DMRS samples for channel estimation. The buffer capacity may be indicative of the DMRS processing window size supported by the UE 120.

In some cases, the UE 120 may indicate a DMRS processing window size from a set of candidate DMRS processing window sizes. That is, given that different UEs 120 may have different DMRS processing window sizes, it may be more efficient for the UE 120 to indicate a quantized value indicative of the DMRS processing window size of the UE 120 (e.g., instead of an actual value of the DMRS processing window size supported by the UE 120). For example, the UE 120 may indicate, from a set of candidate DMRS processing window sizes {L1, L2, . . . . Lk}, a DMRS processing window size that is a closest value to the buffer capacity of the UE 120 that is smaller than or equal to the value of the buffer capacity of the UE 120. That is, the UE 120 may indicate a value of the DMRS processing window size L̅ of the UE 120, where L̅∈{L1, L2, . . . . Lk}, and L̅ may be chosen to be the closest to and the same or smaller than the actual value of the DMRS processing window size supported by the UE 120. In some cases, the values {L1, L2, . . . . Lk} may be predefined or otherwise preconfigured. Additionally, the UE 120 may support a DMRS processing window size that is at least a threshold quantity of symbols (e.g., L1 symbols). That is, the UE 120 may support at least L1 symbols of extrapolations at the beginning of a TDRA 340 (e.g., that corresponds to an SLIV).

The quantity of DMRS symbols that can be processed by the UE 120 during the DMRS processing window may indicate one or more limitations (if any) on a maximum quantity of DMRS symbols that the UE 120 can process within each DMRS processing window (or each channel estimation window). For example, a higher degree of freedom for the channel 325 in the time domain increases complexity of channel estimation by the UE 120. The quantity of time domain bases that are supported by the UE 120 for the channel estimation may indicate a quantity of DMRS instances that can be configured within a given channel estimation window for the UE 120.

The time domain filtering capability for DMRS-based channel estimation of the UE 120 may indicate whether the UE 120 supports (or is capable of) combining a channel estimate of a current channel estimation window with channel estimate(s) associated with one or more previous channel estimation windows (e.g., time domain filtering along the length of the TDRA 340).

Based on the capability information 305, the network node 110 may transmit, and the UE 120 may receive, the DMRS configuration 310. The network node 110 may transmit the DMRS configuration 310 via one or more of system information (e.g., a master information block (MIB) and/or a system information block (SIB), among other examples), RRC signaling, MAC signaling (e.g., one or more medium access MAC-CEs), and/or physical layer signaling (e.g., DCI), among other examples.

The DMRS configuration 310 may indicate a DMRS pattern configuration that is applicable for fluid SLIVs. For example, the DMRS configuration 310 may indicate one or more parameters for defining the DMRS pattern within a given TDRA 340. The one or more parameters may enable the DMRS pattern to be defined relative to the TDRA 340 (e.g., indicated by a fluid SLIV) without being constrained to a fixed slot format (e.g., as the TDRA 340 may cross a slot boundary and/or span multiple slots). For example, the one or more parameters may be indicative of a DMRS symbol bitmap (e.g., which may indicate DMRS symbol positions within a given TDRA 340).

The one or more parameters indicated by the DMRS configuration 310 may include a time domain spacing parameter, a time domain offset parameter, and/or a window size parameter (e.g., a channel estimation window size or a DMRS processing window size for intra-SLIV or intra-TDRA DMRS combining for channel estimation), among other examples. The window size parameter may correspond to a DMRS processing window size or a channel estimation window size. The UE 120 may combine DMRS information across windows for intra-TDRA DMRS combining when performing channel estimation. In some aspects, the network node 110 may configure at least two DMRS instances in each window. In some aspects, different windows may have different DMRS patterns (e.g., different time domain spacing pattern information, different time domain spacing parameters, and/or different time domain offset parameters) within a given TDRA 340.

The initial time domain offset parameter (A) may indicate an initial time domain offset 330 that corresponds to a starting time domain location of a first DMRS instance (e.g., first in the time domain) included in a TDRA 340. The initial time domain offset parameter may indicate the initial time domain offset 330 relative to a start of the TDRA 340. In some other examples, the initial time domain offset parameter may indicate the initial time domain offset 330 relative to a start of a first slot included in the TDRA 340 (e.g., a first full slot or a first slot in which the SLIV indicates that the TDRA 340 is to begin). The initial time domain offset 330 may indicate a quantity of OFDM symbols (if any) between the first DMRS instance and the start of the TDRA 340 (or the start of a slot). For example, the initial time domain offset 330 may indicate a quantity of OFDM symbols to be extrapolated for channel estimation.

In some aspects, the initial time domain offset parameter may indicate a value of zero (e.g., indicating that the first DMRS instance is to occur in a first symbol of the TDRA 340 or a first symbol of the first slot). In some other aspects, the initial time domain offset parameter may indicate a value greater than zero (e.g., indicating that the first DMRS instance is to occur a certain quantity of symbols after a first symbol of the TDRA 340 or after a first symbol of the first slot).

In some aspects, the DMRS configuration 310 may additionally indicate a final time domain offset parameter (B) that indicates a quantity of symbols after the last DMRS symbol in the TDRA 340, corresponding to the final time domain offset 345. For example, the final time domain offset parameter may indicate whether a DMRS instance is to occur in a last symbol of the TDRA 340. In some examples, the final time domain offset parameter may be explicitly indicated via a parameter included in the DMRS configuration 310. In other examples, the final time domain offset parameter may be implicitly indicated (e.g., the UE 120 may determine this information based on the time domain spacing parameter, the initial time domain offset parameter, and/or other information in the DMRS configuration 310).

The DMRS configuration 310 may additionally indicate a time domain spacing parameter. The time domain spacing parameter may indicate an inter-DMRS spacing or a time domain spacing 335 (e.g., in terms of a quantity of OFDM symbols) between DMRS instances in a given TDRA 340. The time domain spacing parameter may indicate one or more time gaps (e.g., the time domain spacing 335) between DMRS instances included in the TDRA 340. In some cases, the network node 110 may select a time domain spacing parameter based on a Doppler scenario associated with the channel 325. For example, if the channel 325 is associated with a lower Doppler (e.g., if a Doppler shift associated with communications on the channel 325 is below a threshold Doppler shift), the network node 110 may select a higher time domain spacing parameter for the DMRS configuration 310 (e.g., to configure less frequent DMRS symbol instances). Additionally, if the channel 325 is associated with a higher Doppler (e.g., if the Doppler shift associated with communications on the channel 325 is above a threshold Doppler shift), the network node 110 may select a lower time domain spacing parameter for the DMRS configuration 310 (e.g., to configure more frequent DMRS symbol instances).

The time domain spacing parameter may indicate a uniform time gap that occurs between each DMRS instance included in the TDRA. In such examples, the time domain spacing parameter may indicate a single value, which may indicate a time gap (e.g., a quantity of OFDM symbols) between each DMRS instance. If each DMRS instance includes a single DMRS symbol (e.g., for single symbol instances), the time domain spacing parameter may correspond to a difference in symbol indices between the DMRS symbols across instances. If each DMRS instance includes more than one DMRS symbol (e.g., two, three, or more DMRS symbols, such as a double symbol instance), the time domain spacing parameter may correspond to a difference in symbol indices between the first of the more than one DMRS symbol across instances. Additionally, if the DMRS configuration 310 indicates that the time domain spacing parameter is ‘0’, the DMRS configuration 310 may configure only a single DMRS symbol in the TDRA 340.

In some aspects, the time domain spacing parameter may be indicated from a set of candidate time domain spacings. In some aspects, the set of candidate time domain spacings (Q) may range from zero to |Q|−1, where |Q| corresponds to the quantity of candidate time domain spacings in the set (Q). For example, the set of candidate time domain spacings (Q) may be defined according to Equation 1:

$$Q = \{ {S}_{0} , {S}_{1} , {S}_{2} , … , {S}_{\vert Q \vert - 1} \} , where 0 < {S}_{0} < {S}_{1} < … {S}_{\vert Q \vert - 1} \qquad ( 1 )$$

In the example of Equation 1, the time domain spacing parameter S may be selected from the set Q (e.g., S∈Q), and may correspond to the time domain spacing parameter indicated by the DMRS configuration 310 (e.g., indicated by DCI). To indicate the time domain spacing parameter S from the set Q that includes |Q| values, the network node 110 may transmit an indication that includes ┌log 2(|Q|)┐ bits. Additionally, the network node 110 may indicate the initial time domain offset parameter A from a set of candidate initial time domain offsets that includes S_{|Q|-1} values. Accordingly, to indicate the initial time domain offset parameter A from the set of candidate initial time domain offsets that includes | Q| values, the network node 110 may transmit an indication that includes ┌log 2(S_{|Q|-1})┐ bits. In this example, the DMRS configuration 310 may include ┌log 2(|Q|)┐+┌log 2(S_{|Q|-1})┐ bits to indicate the initial time domain offset parameter and the time domain spacing parameter. In some cases, the network node 110 may similarly indicate the final time domain offset parameter B from a set of candidate final time domain offsets that also include S Ql-1 values.

In the example wireless communication network 300, the set of candidate initial time domain offsets may be limited (e.g., may be decreased in size) based on the time domain spacing parameter S indicated by the DMRS configuration 310. That is, the set of candidate initial time domain offsets may be based on the time domain spacing parameter S. For example, the set of candidate initial time domain offsets may be defined to include no more than S/2 symbols. That is, the initial time domain offset 330 may be no more than S/2 symbols from the start of the TDRA 340. Additionally, or alternatively, the network node 110 may similarly indicate the final time domain offset parameter B from a set of candidate final time domain offsets that includes no more than S/2 symbols. Accordingly, to indicate the initial time domain offset parameter A from the set of candidate initial time domain offsets (and, in some cases, to indicate the final time domain offset parameter B), the network node 110 may transmit an indication that includes ┌log 2(S/2)┐ bits, which may include fewer bits than ┌log 2(S)_{|Q|-1})┐. By limiting the set of candidate initial time domain offsets based on the configured time domain spacing parameter S, the network node 110 may decrease the signaling overhead associated with transmitting the DMRS configuration 310 (e.g., based on ┌log 2(S/2)┐ including fewer bits than ┌log 2(S_{|Q|-1})┐).

In some examples, to indicate the initial time domain offset parameter A based on the configured time domain spacing parameter S, the network node 110 may jointly encode the initial time domain offset parameter A and the time domain spacing parameter S into a common indicator. The set of the indicator values for the time domain spacing parameter S (e.g., the inter-DMRS separation) and the initial time domain offset parameter A (e.g., the starting DMRS offset) may be represented in the form of a table. Additionally, or alternatively, the network node 110 may jointly encode the final time domain offset parameter B and the time domain spacing parameter S into a common indicator, and the set of indicator values for the time domain spacing parameter S and the final time domain offset parameter B (and, in some cases, the initial time domain offset parameter A) may be jointly encoded and represented in the form of a table.

An example table that corresponds to the joint encoding of the initial time domain offset parameter A and the time domain spacing parameter S is illustrated below by Table 1. Table 1 illustrates an example where, to decrease the signaling overhead of the DMRS configuration 310, the network node 110 jointly encodes the initial time domain offset parameter A and the time domain spacing parameter S into an indicator that includes a smaller bit width than a bit width associated with indicating the initial time domain offset parameter A and the time domain spacing parameter S independently. Table 1 illustrates an example where the range of the time domain spacing parameter S is associated with at least 2 DMRS symbols in a TDRA 340 that includes at least 14 symbols. Table 1 illustrates an example where the DMRS configuration 310 includes a 1-bit reduction in signaling overhead.

TABLE 1
Joint Signaling for S and A

| | A = 0 | A = 1 | A = 2 | A = 3 | A = 4 | A = 5 |
|---|---|---|---|---|---|---|
| S = 0 | 1 | N/A | N/A | N/A | N/A | N/A |
| S = 1 | 2 | N/A | N/A | N/A | N/A | N/A |
| S = 2 | 3 | N/A | N/A | N/A | N/A | N/A |
| S = 3 | 4 | 14 | N/A | N/A | N/A | N/A |
| S = 4 | 5 | 15 | N/A | N/A | N/A | N/A |
| S = 5 | 6 | 16 | 24 | N/A | N/A | N/A |
| S = 6 | 7 | 17 | 25 | N/A | N/A | N/A |
| S = 7 | 8 | 18 | 26 | 32 | N/A | N/A |
| S = 8 | 9 | 19 | 27 | 33 | N/A | N/A |
| S= | 10 | 20 | 28 | 34 | 38 | N/A |
| S = 10 | 11 | 21 | 29 | 35 | 39 | N/A |
| S = 11 | 12 | 22 | 30 | 36 | 40 | 42 |
| S = 12 | 13 | 23 | 31 | 37 | 41 | 43 |

In the example illustrated by Table 1, where the indications of the time domain spacing parameter S and the initial time domain offset parameter A are jointly indicated, the indications of the time domain spacing parameter S and the initial time domain offset parameter A may include a total of 6 bits. However, if the time domain spacing parameter S and the initial time domain offset parameter A were to have been independently signaled, the indications of the time domain spacing parameter S and the initial time domain offset parameter A may include a total of 7 bits.

If the network node 110 jointly encodes the initial time domain offset parameter A and time domain spacing parameter S (e.g., within the DMRS configuration 310), and if the network node 110 indicates a value ‘0,’ for the time domain spacing parameter S, the network node 110 and the UE 120 may determine that only a single DMRS instance is scheduled within the TDRA 340. In one example, the single DMRS instance may be configured to be within the first symbol of the TDRA 340. Accordingly, the UE 120 may determine that the initial time domain offset 330 is also set to ‘0’ (e.g., the single DMRS is frontloaded within the TDRA 340). In another example, any initial time domain offset 330 may be configured when the time domain spacing parameter S is set to ‘0.’ For example, the initial time domain offset parameter A may indicate any value between ‘0’ and the length of the SLIV (e.g., the length of the TDRA 340). Here, if the initial time domain offset parameter A is set to a value that is equal to the length of the SLIV, the DMRS configuration 310 may configure the single DMRS instance to be in the last symbol of the TDRA 340.

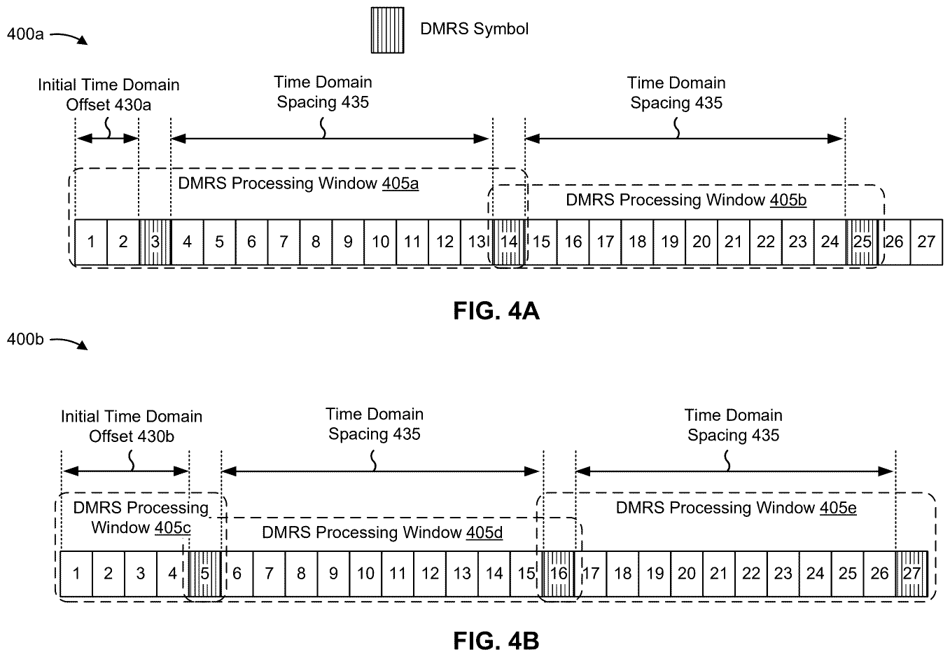

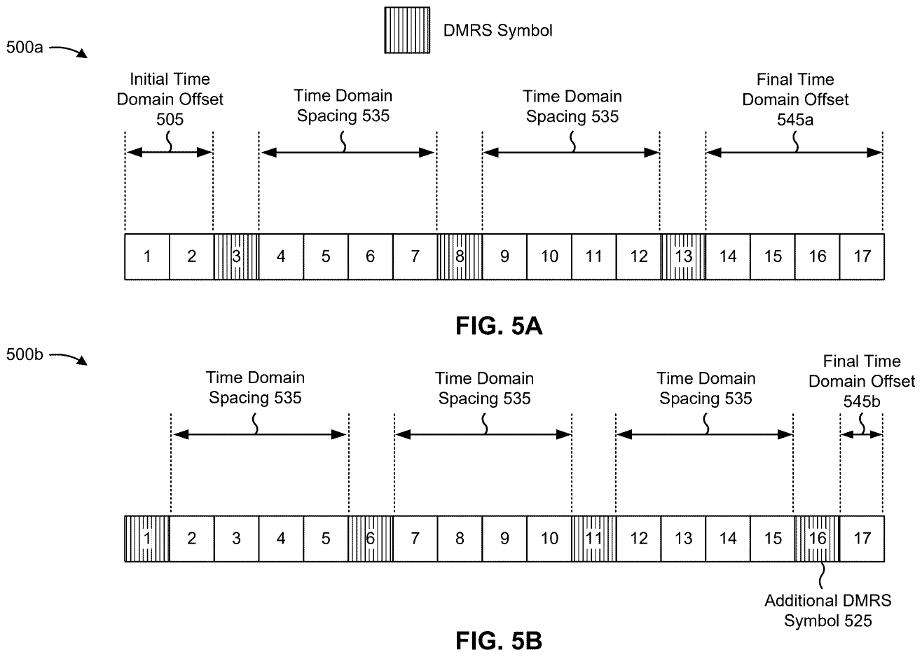

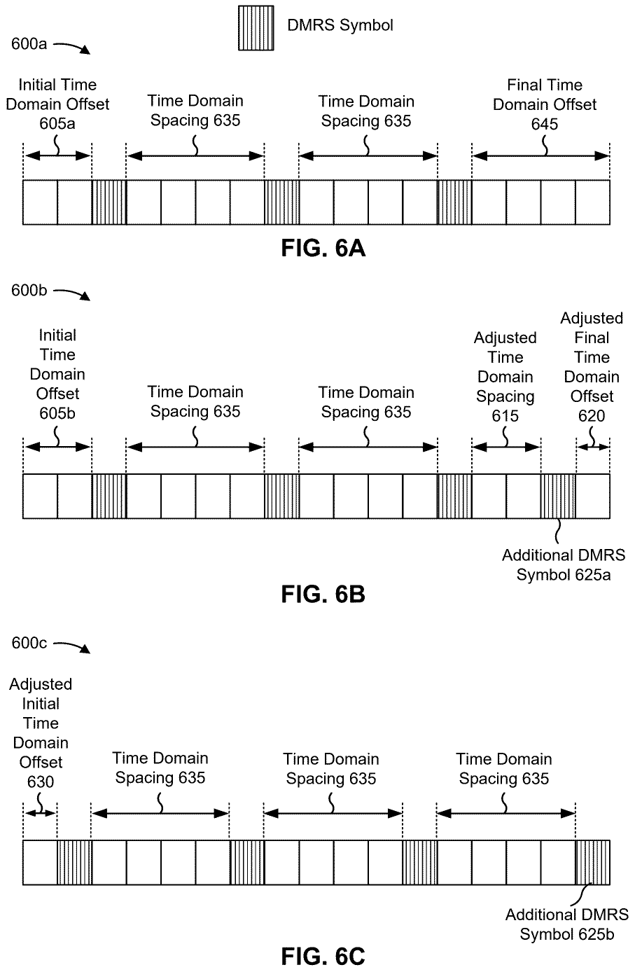

If the DMRS configuration 310 indicates that the time domain spacing parameter S is greater than ‘0,’ the set of candidate initial time domain offset parameters may be limited, based on the configured time domain spacing parameter S. For example, the set of candidate initial time domain offset parameters may be limited to only include candidate initial time domain offset parameters that are less than or equal to a function of the configured time domain spacing parameter S (e.g., 0≤A≤ƒ(S), where ƒ is a function representing the dependence of A on S). For example, the set of candidate initial time domain offset parameters may be limited to only include candidate initial time domain offset parameters that are less than or equal to a floor of (S/2) (e.g., 0≤A≤└S/2┘). In some other cases, the function ƒ(S) may be based on a length of the DMRS processing window (e.g., as described below with reference to FIGS. 4A and 4B), one or more UE capabilities (e.g., as described below with reference to FIGS. 5A, 5B, 6A, 6B, and 6C), or an MCS associated with data transmitted in the channel 325.

Additionally, or alternatively, the set of candidate final time domain offset parameters may be limited based on the configured time domain spacing parameter S. For example, the set of candidate final time domain offset parameters may be limited to only include candidate final time domain offset parameters that are less than or equal to the function of the configured time domain spacing parameter S (e.g., 0≤B≤ƒ(S), where ƒ is a function representing the dependence of B on S). For example, the set of candidate final time domain offset parameters may be limited to only include candidate final time domain offset parameters that are less than or equal to a floor of (S/2).

In an example where the function of the time domain spacing parameter ƒ(S) (e.g., that limits the set of candidate initial time domain offset parameters) is dependent on the MCS associated with the data transmitted in the channel 325, the network node 110 may select the initial time domain offset parameter based on the MCS. An operating MCS (or, in some other cases, an operating carrier-to-interference-plus-noise ratio (CINR)) may correspond to a quality of extrapolations at a corresponding Doppler. For example, extrapolated channel estimations performed by the UE 120 may be increasingly dominated by a quality of the channel 325 as the CINR and/or MCS associated with the data transmissions via the channel 325 increases. Accordingly, the network node 110 may select larger initial time domain offsets 330 at lower CINRs and/or MCSs, and a smaller initial time domain offset 330 at higher CINRs and/or MCSs to ensure that a channel estimation performance of the UE 120 is balanced across a length of the TDRA 340 (e.g., that corresponds to a fluid SLIV).

In one example where the function of the time domain spacing parameter ƒ(S) (e.g., that limits the set of candidate initial time domain offset parameters) is dependent on the MCS, the network node 110 may select an initial time domain offset parameter S based on a backoff function that is further based on the MCS associated with the data transmitted in the channel 325. For example, the set of candidate initial time domain offset parameters may be limited to only include candidate initial time domain offset parameters that are less than or equal to ƒ(S)−g(MCS), where g(MCS) corresponds to the backoff function that is based on the MCS associated with the data transmitted in the channel 325. Here, the candidate initial time domain offset parameters may be limited according to 0≤A≤max (0, ƒ(S)−g(MCS)). In some cases, the backoff function may be defined according to Equation 2, provided below.

$$g ( M C S ) = \{ \begin{matrix}0 if 0 < MCS \leq {MCS}_{1} \\ 1 if {MCS}_{1} < MCS \leq {MCS}_{2} \\ N , if MCS > {MCS}_{N}\end{matrix} \qquad ( 2 )$$

In Equation 2, the various MCS thresholds (e.g., MCS₁, MCS₂, . . . . MCS_{N}) may be defined or otherwise preconfigured. Additionally, or alternatively, the candidate final time domain offsets may be limited according to 0≤B≤max (0,ƒ(S)−g(MCS)).

In another example, the network node 110 may select the initial time domain offset parameter A according to one or more ranges that are defined by an intersection of one or more sets of candidate initial time domain offset parameters. For example, if the configured time domain spacing parameter S is small, and the channel 325 is associated with a high Doppler (e.g., a Doppler that is greater than or equal to a predefined or preconfigured threshold), the network node 110 may disregard Equation 2 for determination of the initial time domain offset parameter A Additionally, if the UE 120 reports a large DMRS processing window size (e.g., within the capability information 305), the network node 110 may disregard the reported capability of the UE 120 (e.g., as described with reference to FIGS. 4A and 4B) for determination of the initial time domain offset parameter A.

In some cases, the network node 110 may indicate, within the DMRS configuration 310, a time domain spacing parameter S, an initial time domain offset parameter A, a final time domain offset parameter B, and a quantity of DMRS instances M to be included in the TDRA 340. Here, the UE 120 may determine a length of the fluid SLIV (e.g., a length of the TDRA 340) based on the configured time domain spacing parameter S, the configured initial time domain offset parameter A, the final time domain offset parameter B, and the configured quantity of DMRS instances M in the TDRA 340. That is, the network node 110 may configure the time domain spacing parameter S, the initial time domain offset parameter A, the final time domain offset parameter B, and the quantity of DMRS instances M to be included in the TDRA 340 such that the initial time domain offset parameter A is within a candidate set of initial time domain offset parameters (e.g., as described herein) and the final time domain offset parameter B is within a candidate set of final time domain offset parameters. Accordingly, the UE 120 may determine the length of the TDRA 340 T according to Equation 3, provided below.

$$T = A + B + M * x + ( M - 1 ) * S \qquad ( 3 )$$

In Equation 3, x may correspond to a quantity of DMRS symbols within each DMRS instance. For example, each DMRS instance may include a single DMRS symbol, and in this example x=1. Additionally, each DMRS instance may include two DMRS symbols, and here x=2. Additionally, the length of the TDRA 340 (e.g., T) may be less than a transport block size limit that is associated with a maximum SLIV length.

In some other cases, the network node 110 may indicate the length of the TDRA 340 (e.g., T), and the UE 120 may determine and/or adjust one or more of the time domain spacing parameter S, the initial time domain offset parameter A, the final time domain offset parameter B, and the quantity of DMRS instances M to be included in the TDRA 340 based on the indicated length of the TDRA 340. The maximum length of the TDRA 340 (e.g., that corresponds to a maximum SLIV length) may be limited by a maximum transport block size that the UE 120 is capable of supporting, which may be indicated within the capability information 305. Based on the conditions of the channel 325 (e.g., traffic load presence of other wireless devices), a PHY scheduler (e.g., at the network node 110) may determine the quantity of symbols in the TDRA 340 (e.g., in the SLIV corresponding to the TDRA 340) and indicate the quantity of symbols in the TDRA 340 (e.g., the length of the TDRA 340, T) to the UE 120 via DCI.

In some examples where the network node 110 indicates the length of the TDRA 340 to the UE 120, the network node 110 may configure the time domain offset parameter B based on the length of the TDRA 340 (e.g., T), the initial time domain offset parameter A, and a configured quantity of DMRS instances M that are included in the TDRA 340 according to Equation 4, provided below.

$$B = T - A - M * x - ( M - 1 ) * S \qquad ( 4 )$$

In some cases, the network node 110 may configure the time domain offset parameter B based on the length of the TDRA 340 (e.g., T), the initial time domain offset parameter A, and a configured quantity of DMRS instances M that are included in the TDRA 340 based on the constraints associated with the initial time domain offset parameter A being stricter than the constraints associated with the final time domain offset parameter B. In some cases, configuring the values of A and B to be as close as possible may enable the UE 120 to perform a more symmetric channel estimation at the edges of the TDRA 340 (e.g., that corresponds to a SLIV). In some cases, the network node 110 may select the quantity of DMRS instances M for a given length of the TDRA 340, a given time domain spacing parameter S, and a given initial time domain offset parameter A such that the final time domain offset parameter B is selected from a same set of candidate time domain offset parameters as the initial time domain offset parameter A.

In addition to transmitting signaling indicating the DMRS configuration 310, the network node 110 may transmit, and the UE 120 may receive, an SLIV indication 315. The SLIV indication 315 may indicate the TDRA 340 associated with the channel 325. In the example wireless communication network 300, the SLIV indication 315 may indicate that the TDRA 340 is not confined or limited to a single slot (e.g., a fluid SLIV).

The network node 110 may transmit, and the UE 120 may receive, the DMRS 320. In some cases, the DMRS 320 may be transmitted in accordance with the DMRS configuration 310.

The DMRS may carry information used to estimate a radio channel for demodulation of an associated channel 325 (e.g., PDCCH, PDSCH, PBCH, PUCCH, or PUSCH). The design and mapping of the DMRS 320 may be specific to the channel 325 for which the DMRS 320 is used for estimation. The DMRS 320 may be UE-specific, may be beamformed, may be confined in a scheduled resource (e.g., rather than transmitted on a wideband), and may be transmitted only when necessary. Additionally, while the DMRS 320 is illustrated within a downlink communication, in other examples the UE 120 may transmit a DMRS (e.g., similar to the DMRS 320) in the uplink.

While FIG. 3 illustrates an example of a DMRS pattern configuration, the techniques and aspects described herein may be similarly applicable to other types of pilot signals, such as a phase tracking reference signal, a cell specific reference signal (CRS), a CSI-RS, a beamforming reference signal, and/or one or more synchronization signals (for example, a PSS or an SSS). Additionally, the techniques and aspects described herein may be applicable to downlink pilot signals, uplink pilot signals, and/or sidelink pilot signals.

As indicated above, FIG. 3 is provided as an example. Other examples may differ from what is described with respect to FIG. 3.

FIGS. 4A and 4B are diagrams illustrating example DMRS configurations 400, in accordance with the present disclosure. In some cases, the DMRS configurations 400 may correspond to DMRS configurations indicated to a UE 120, by a network node 110, as described with reference to FIG. 3. For example, the network node 110 may indicate the DMRS configuration 400a or the DMRS configuration 400b to the UE 120 via the DMRS configuration 310. The example DMRS configurations 400 may correspond to DMRS configurations where the set of candidate initial time domain offset parameters, for a given time domain spacing parameter S, are based on the DMRS processing window 405 of the UE 120.

As described with reference to FIG. 3, a UE 120 may transmit, and a network node 110 may receive, capability information that indicates a DMRS processing window size of the UE 120. The DMRS processing window size may correspond to an amount of time during which the UE 120 is capable of storing data samples and/or DMRS samples for channel estimation. In some cases, the DMRS processing window size indicated by the capability information 305 may correspond to the exact buffer size of the UE 120. In some other cases, the DMRS processing window size indicated by the capability information 305 may correspond to a quantized DMRS processing window size (e.g., L̅) that is selected from a set of quantized candidate DMRS processing window sizes (e.g., {L1, L2, . . . . Lk}). That is, the UE 120 may indicate the value L̅, where L̅∈{L1, L2, . . . . Lk}, and the UE 120 may choose L̅ from the set based on L being the closest in size to, and the same or smaller than an actual DMRS processing window supported by the UE 120.

The set of candidate initial time domain offsets may be based on the DMRS processing window size of the UE 120, but the set of candidate final time domain offsets may be independent of the DMRS processing window size of the UE 120. That is, the buffer at the UE 120 that corresponds to the DMRS processing window size of the UE 120 may be used to store symbols until a last DMRS symbol prior to the joint channel estimation, which the UE 120 then uses to extrapolate symbols (e.g., after the last DMRS symbol). That is, the UE 120 may not store any of the symbols of the final time domain offset within the buffer at the UE 120. Accordingly, the set of candidate final time domain offsets may not be based on the DMRS processing window size of the UE 120.

In the example DMRS configurations 400, the DMRS processing window size is 14 symbols and the configured time domain spacing parameter S indicates a time domain spacing 435 of 10 symbols.

The DMRS configurations 400 may additionally be based on a quantity of DMRS symbols within each DMRS processing window 405 to enable the UE 120 to perform reliable channel estimations (e.g., a minimum quantity of DMRS symbols within each DMRS processing window 405). In some cases, the UE 120 may indicate, to the network node 110, the quantity of DMRS symbols within each DMRS processing window 405 within the capability information (e.g., the capability information 305). Additionally, or alternatively, the network node 110 may determine the minimum quantity of DMRS symbols within each DMRS processing window 405 based on one or more parameters associated with the UE 120 and/or communications between the UE 120 and the network node. For example, the minimum quantity of DMRS symbols within each DMRS processing window 405 may be based on a Doppler associated with communications between the UE 120 and the network node 110. For example, higher Dopplers may correspond to a larger quantity of DMRS symbols used by the UE 120 within each DMRS processing window 405. Additionally, lower Dopplers may correspond to a smaller quantity of DMRS symbols used by the UE 120 within each DMRS processing window 405.

In some cases, UEs 120 with low throughput or low block error rate thresholds (e.g., such as IoT devices) may be configured with DMRS processing windows 405 that include more than one DMRS symbol at all configured values of time domain spacing parameters S and for every Doppler scenario (e.g., even at low Dopplers). That is, configuring each DMRS processing window 405 to include more than one DMRS symbol may be associated with an improved processing gain as compared to DMRS processing windows 405 that include only a single DMRS symbol.

In FIG. 4A, the UE 120 may require two or more DMRS symbols per DMRS processing window 405 to perform channel estimations. In one example, the UE 120 may indicate, to the network node 110 (e.g., via the capability information 305) that the UE 120 requires two or more DMRS symbols per DMRS processing window 405. In another example, the network node 110 may determine that the UE 120 requires two or more DMRS symbols per DMRS processing window based on the Doppler conditions associated with the channel 325.

Based on the UE 120 requiring the two or more DMRS symbols per DMRS processing window 405, the selected time domain spacing parameter S indicating the time domain spacing 435 of 10 symbols, and the UE 120 being capable of supporting a DMRS processing window 405 that is up to 14 symbols long, the network node 110 may determine that the set of candidate initial time domain offsets is limited to initial time domain offsets that are less than or equal to two symbols. That is, if the initial time domain offset 430a is greater than two symbols, the first DMRS processing window 405a may not include two DMRS symbols. Accordingly, the DMRS configuration 310 may indicate the initial time domain offset parameter from a set of candidate initial time domain offset parameters (e.g., A∈{0, 1, 2}).

In the example DMRS configuration 400a, the network node 110 may configure an initial time domain offset parameter A that indicates an initial time domain offset 430a of two symbols. Further, the first DMRS processing window 405a may include 14 symbols (e.g., the symbols corresponding to the symbol index ‘1’ through the symbol index ‘14’) and two DMRS symbols (e.g., corresponding to the symbol index ‘3’ and the symbol index ‘14’), and the second DMRS processing window 405b may include 12 symbols (e.g., the symbols corresponding to the symbol index ‘15’ through the symbol index ‘25’) and two DMRS symbols (e.g., corresponding to the symbol index ‘14’ and the symbol index ‘25’).

In FIG. 4B, the UE 120 may require one or more DMRS symbols per DMRS processing window 405 to perform channel estimations. In one example, the UE 120 may indicate, to the network node 110 (e.g., via the capability information 305) that the UE 120 requires one or more DMRS symbols per DMRS processing window 405. In another example, the network node 110 may determine that the UE 120 requires one or more DMRS symbols per DMRS processing window based on the Doppler conditions associated with the channel 325. In some cases, the UE 120 may require only one DMRS symbol per DMRS processing window 405 in very low Doppler scenarios (e.g., where one DMRS symbol enables the UE 120 perform channel estimations with error rates above a threshold).

Based on the UE 120 requiring the one or more DMRS symbols per DMRS processing window 405, the selected time domain spacing parameter S indicating the time domain spacing 435 of 10 symbols, and the UE 120 being capable of supporting a DMRS processing window 405 that is up to 14 symbols long, the network node 110 may determine that the set of candidate initial time domain offsets is limited to initial time domain offsets that are less than or equal a quantity of symbols corresponding to S−1 symbols. That is, A € {0, 1, . . . , S−1}. In the example DMRS configuration 400b, the set of candidate initial time domain offsets may include initial time domain offsets that are less than or equal to ten symbols (e.g., S−1=10−1=9). That is, the network node may indicate the initial time domain offset parameter A from the set of candidate initial time domain offset parameters (e.g., A∈{0, 1, . . . ,9}). If the configured time domain spacing parameter S is relatively large, a theoretical maximum of the initial time domain offset parameter A may also be relatively large (e.g., S−1). Therefore, the network node 110 may select an initial time domain offset parameter A that is less than the upper limit of the initial time domain offset parameter A.

In the example DMRS configuration 400b, the network node 110 may configure an initial time domain offset parameter A that indicates an initial time domain offset 430b of four symbols. Further, the first DMRS processing window 405c may include five symbols (e.g., the symbols corresponding to the symbol index ‘1’ through the symbol index ‘5’) and one DMRS symbol (e.g., corresponding to the symbol index ‘5’), the second DMRS processing window 405d may include 12 symbols (e.g., the symbols corresponding to the symbol index ‘5’ through the symbol index ‘16’) and two DMRS symbols (e.g., corresponding to the symbol index ‘16’), and the third DMRS processing window 405e may include 12 symbols (e.g., the symbols corresponding to the symbol index ‘16’ through the symbol index ‘27’) and two DMRS symbols (e.g., corresponding to the symbol index ‘16’ and the symbol index ‘27’).

As indicated above, FIGS. 4A and 4B are provided as examples. Other examples may differ from what is described with respect to FIGS. 4A and 4B.

FIGS. 5A and 5B are diagrams illustrating example DMRS configurations 500, in accordance with the present disclosure. In some cases, the DMRS configurations 500 may correspond to DMRS configurations indicated to a UE 120, by a network node 110, as described with reference to FIG. 3. For example, the network node 110 may indicate the DMRS configurations 500 to the UE 120 via the DMRS configuration 310. The example DMRS configurations 500 correspond to an example where the network node 110 adjusts one or more parameters associated with a configured DMRS to ensure that the final time domain offset 545b is within a set of candidate final time domain offset parameters.

The example DMRS configuration 500a illustrates a DMRS configuration where, for a certain length of the TDRA T, initial time domain offset parameter A, and time domain spacing parameter S, there is no integer quantity of DMRS instances within a TDRA M that results in a final time domain offset 545a that corresponds to one of the final time domain offset parameters B within the set of candidate final time domain offset parameters. Additionally, the example DMRS configuration 500b illustrates an example adjustment made to the initial time domain offset parameter A and the quantity of DMRS instances within the TDRA M to cause the final time domain offset 545b to correspond to one of the final time domain offset parameters B within the set of candidate final time domain offset parameter.

In the example DMRS configurations 500, the network node 110 may indicate, via a DMRS configuration, that the length of the SLIV is 17 symbols (e.g., the TDRA 340 includes 17 symbols). The network node 110 may additionally indicate that the SLIV includes three DMRS symbols (e.g., M=3). Additionally, the network node 110 may configure the time domain spacing parameter S to be four symbols (e.g., the time domain spacing 535 is four symbols). Based on the configured time domain spacing parameter S, the set of initial candidate time domain offsets may be limited to only include candidate initial time domain offsets that are less than or equal to S/2 (e.g., A∈0, 1, . . . . S/2}. In the example DMRS configurations 500, the set of initial candidate time domain offsets may correspond {0, 1, 2}.

FIG. 5A illustrates the resulting DMRS configuration 500a, where the initial time domain offset 505 includes two symbols and the final time domain offset 545a includes four symbols. However, in the example DMRS configuration 500a, the final time domain offset 545a is not within the set of candidate final time domain offset parameters. That is, if the set of candidate final time domain offset parameters is limited similarly to the set of candidate initial time domain offset parameters (e.g., B∈{0, 1, . . . . S/2}, the final time domain offset parameter B is selected from a set such that B∈{0,1,2}. However, and as illustrated in FIG. 5A, when the largest initial time domain offset parameter A is selected from the set of candidate initial time domain offset parameters (e.g., two symbols), the resulting final time domain offset 545a is not within the limited set of candidate final time domain offset parameters. That is, the largest candidate final time domain offset parameter is two symbols, and the final time domain offset 545a is four symbols.

FIG. 5B illustrates an example adjustment to the DMRS configuration 500a to obtain the DMRS configuration 500b when the value of the final time domain offset parameter B determined by the time domain spacing parameter S and the initial time domain offset parameter A is outside of the set of candidate final time domain offset parameters. In particular, the DMRS configuration 500a may be adjusted by adding another DMRS instance to the TDRA. Accordingly, the DMRS configuration 500b may include an additional DMRS symbol 525 (e.g., four DMRS symbols) as compared to the DMRS configuration 500a. Additionally, the adjustments may include setting the initial time domain offset parameter A to zero, so that the first symbol in the TDRA includes a DMRS instance. Based on the adjustments, the DMRS configuration 500b may include an additional DMRS instance in the TDRA (e.g., as compared to the initially configured DMRS configuration 500a), the initial time domain offset 505 of two symbols is adjusted to instead be zero (e.g., the first symbol of the TDRA includes a DMRS symbol), and the resulting final time domain offset 545b is one symbol, which does correspond to a final time domain offset parameter B that is within the set of candidate final time domain offset parameters (e.g., B∈{0,1,2}). Additionally, the time domain spacing 535 may remain unchanged, and may correspond to the configured time domain spacing parameter S.

As indicated above, FIGS. 5A and 5B are provided as examples. Other examples may differ from what is described with respect to FIGS. 5A and 5B.

FIGS. 6A, 6B, and 6C are diagrams illustrating example DMRS configurations 600, in accordance with the present disclosure. In some cases, the DMRS configurations 600 may correspond to DMRS configurations indicated to a UE 120, by a network node 110, as described with reference to FIG. 3. For example, the network node 110 may indicate the DMRS configurations to the UE 120 via the DMRS configuration 310. The example DMRS configurations 600 correspond to an example where the network node 110 adjusts one or more parameters associated with a configured DMRS to ensure that the final time domain offset 645 is within a set of candidate final time domain offset parameters.

The example DMRS configuration 600a illustrates a DMRS configuration where, for a certain length of the TDRA T, initial time domain offset parameter A, and time domain spacing parameter S, there is no integer quantity of DMRS instances within a TDRA M that results in a final time domain offset 645a that corresponds to one of the final time domain offset parameters B within the set of candidate final time domain offset parameters. Additionally, the example DMRS configuration 600b and the example DMRS configuration 600c illustrate example adjustments made to the initial time domain offset parameter A, the quantity of DMRS instances within the TDRA M, and/or one or more of the time domain spacings 635 to cause the final time domain offset 645 to correspond to one of the final time domain offset parameters B within the set of candidate final time domain offset parameters.

In the example DMRS configurations 600, the network node 110 may indicate, via a DMRS configuration, that the length of the SLIV is 17 symbols (e.g., the TDRA 340 includes 17 symbols). The network node 110 may additionally indicate that the SLIV includes three DMRS symbols (e.g., M=3). Additionally, the network node 110 may configure the time domain spacing parameter S to be four symbols (e.g., the time domain spacing 635 is four symbols). Based on the configured time domain spacing parameter S, the set of initial candidate time domain offsets may be limited to only include candidate initial time domain offsets that are less than or equal to S/2 (e.g., A∈{0, 1, . . . . S/2}. In the example DMRS configurations 600, the set of initial candidate time domain offsets may correspond to {0, 1, 2}.

FIG. 6A illustrates the resulting DMRS configuration 600a, where the initial time domain offset 605 includes two symbols and the final time domain offset 645a includes four symbols. However, in the example DMRS configuration 600a, the final time domain offset 645a is not within the set of candidate final time domain offset parameters. That is, if the set of candidate final time domain offset parameters is limited similarly to the set of candidate initial time domain offset parameters (e.g., B∈{0, 1, . . . . S/2}, the final time domain offset parameter B is selected from a set such that B∈{0,1,2}. However, and as illustrated in FIG. 6A, when the largest initial time domain offset parameter A is selected from the set of candidate initial time domain offset parameters (e.g., two symbols), the resulting final time domain offset 645a is not within the limited set of candidate final time domain offset parameters. That is, the largest candidate final time domain offset parameter is two symbols, and the final time domain offset 645a is four symbols.

FIG. 6B illustrates an example adjustment to the DMRS configuration 600a to obtain the DMRS configuration 600b when the value of the final time domain offset parameter B determined by the time domain spacing parameter S and the initial time domain offset parameter A is outside of the set of candidate final time domain offset parameters. In particular, the DMRS configuration 600a may be adjusted by adding another DMRS instance to the end of the TDRA. Accordingly, the DMRS configuration 600b may include an additional DMRS symbol 625a (e.g., four DMRS symbols) as compared to the DMRS configuration 600a. Additionally, the adjustments may include maintaining the initial time domain offset parameter A (e.g., keeping the initial time domain offset 605b that is indicated by the initial time domain offset parameter A).

Based on maintaining the initial time domain offset parameter A and adding the additional DMRS symbol 625a to the end of the TDRA, the last time domain spacing (e.g., the time domain spacing between the last two DMRS symbols in the TDRA) may be an adjusted time domain spacing 615. In the example DMRS configuration 600b, the time domain spacing between the last two DMRS instances within the TDRA may be adjusted from the configured time domain spacing 635 of four symbols to an adjusted time domain spacing 615 of two symbols. The adjusted time domain spacing 615 may be determined by selecting the next smallest time domain spacing parameter S′ from the set of candidate time domain spacing parameters Q that results in the adjusted final time domain offset 620 being within the set of candidate final time domain offset parameters. Based on the adjustments that resulted in the additional DMRS symbol 625a and the adjusted time domain spacing 615 (between the last two DMRS symbols within the TDRA), the resulting adjusted final time domain offset 620a is one symbol, which does correspond to a final time domain offset parameter B that is within the set of candidate final time domain offset parameters (e.g., B∈{0,1,2}). Additionally, in the example DMRS configuration 600b, the initial time domain offset 605b may remain unchanged (e.g., may still include two symbols).

FIG. 6C illustrates an example adjustment to the DMRS configuration 600a to obtain the DMRS configuration 600c when the value of the final time domain offset parameter B determined by the time domain spacing parameter S and the initial time domain offset parameter A is outside of the set of candidate final time domain offset parameters. In particular, the DMRS configuration 600a may be adjusted by adding another DMRS instance to the end of the TDRA. Accordingly, the DMRS configuration 600c may include an additional DMRS symbol 625b (e.g., four DMRS symbols) as compared to the DMRS configuration 600a. Additionally, the adjustments may include maintaining the configured time domain spacing 635 of four symbols. That is, the time domain spacing 635 between all of the DMRS symbols within the TDRA is uniform and corresponds to the configured time domain spacing parameter S.

Based on maintaining the configured time domain spacing parameter S and adding the additional DMRS symbol 625b to the end of the TDRA, the adjustments to the DMRS configuration 600a to obtain the DMRS configuration 600c may include adjusting the initial time domain offset 605a to obtain the adjusted initial time domain offset 630. In the example DMRS configuration 600c, the initial time domain offset 605a of two symbols may be decreased to an adjusted initial time domain offset 630 of one symbol. The adjusted initial time domain offset 630 may be determined by selecting the next smallest initial time domain offset parameter A′ from the set of candidate initial time domain offset parameters A that results in the TDRA including the additional DMRS symbol 625b while maintaining the uniform time domain spacing 635 that corresponds to the configured time domain spacing parameter S. Based on the adjustments that resulted in the additional DMRS symbol 625b and the adjusted initial time domain offset 630, the resulting final time domain offset is zero (e.g., the last symbol in the TDRA is a DMRS symbol), which does correspond to a final time domain offset parameter B that is within the set of candidate final time domain offset parameters (e.g., B∈{0,1,2}).

As indicated above, FIGS. 6A, 6B, and 6C are provided as examples. Other examples may differ from what is described with respect to FIGS. 6A, 6B, and 6C.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with DMRS pattern configurations.

As shown in FIG. 7, in some aspects, process 700 may include receiving configuration information indicating, for a DMRS, a time domain spacing parameter and a time domain offset parameter (e.g., an initial time domain offset parameter), wherein the time domain offset parameter indicates a first time domain offset (e.g., an initial time domain offset) from a set of first candidate time domain offsets, and wherein the set of first candidate time domain offsets is based at least in part on a time domain spacing indicated by the time domain spacing parameter (block 710). For example, the UE (e.g., using reception component 902 and/or communication manager 906, depicted in FIG. 9) may the receive configuration information via DCI, RRC signaling, or some other type of signaling. In some aspects, the time domain offset parameter indicates a first time domain offset from a set of first candidate time domain offsets. In some aspects, the set of first candidate time domain offsets is based at least in part on a time domain spacing indicated by the time domain spacing parameter. In some cases, the set of first candidate time domain offsets may be limited (e.g., to a smaller set) based on the time domain spacing indicated by the time domain spacing parameter.

As further shown in FIG. 7, in some aspects, process 700 may include receiving an SLIV indicating a TDRA associated with a channel (block 720). For example, the UE (e.g., using reception component 902 and/or communication manager 906, depicted in FIG. 9) may receive an SLIV indicating a TDRA associated with a channel, as described above. The SLIV may be a fluid SLIV. For example, the SLIV may indicate a TDRA that spans multiple slots or that is not limited to being contained within a single slot.

As further shown in FIG. 7, in some aspects, process 700 may include communicating, during the TDRA, one or more DMRSs associated with the channel at one or more respective time domain locations that are based at least in part on the SLIV, the time domain spacing, and the first time domain offset (block 730). For example, the UE (e.g., using reception component 902, transmission component 904, and/or communication manager 906, depicted in FIG. 9) may communicate, during the TDRA, one or more DMRSs associated with the channel at one or more respective time domain locations that are based at least in part on the SLIV, the time domain spacing, and the first time domain offset, as described above. For example, a network node may transmit, and the UE may receive, one or more DMRSs within one or more DMRS symbols throughout the TDRA.

Process 700 may include additional aspects, such as any single aspect or any combination of aspects described below and/or in connection with one or more other processes described elsewhere herein.

In a first aspect, the configuration information comprises a single value indicative of both the time domain spacing parameter and the time domain offset parameter.

In a second aspect, alone or in combination with the first aspect, process 700 includes transmitting capability information associated with a DMRS configuration, wherein the set of first candidate time domain offsets is further based at least in part on the capability information.

In a third aspect, alone or in combination with one or more of the first and second aspects, the capability information is based at least in part on a DMRS processing window size of the UE, a buffer capacity of the UE, a quantity of DMRS symbols that can be processed by the UE during a DMRS processing window, a quantity of time domain bases that are supported by the UE for channel estimation, or a time domain filtering capability of the UE for DMRS-based channel estimation.

In a fourth aspect, alone or in combination with one or more of the first through third aspects, the set of first candidate time domain offsets is further based at least in part on an MCS associated with data transmitted in the channel.

In a fifth aspect, alone or in combination with one or more of the first through fourth aspects, the time domain spacing corresponds to one or more time gaps that occur between each DMRS instance included in the TDRA.

In a sixth aspect, alone or in combination with one or more of the first through fifth aspects, the first time domain offset indicates a starting time domain location of a first DMRS instance included in the TDRA.

In a seventh aspect, alone or in combination with one or more of the first through sixth aspects, the respective time domain locations for communicating the one or more DMRSs are further based at least in part on a second time domain offset indicative of a time domain location of a last DMRS instance included in the TDRA, the second time domain offset is from a set of second candidate time domain offsets, and the set of second candidate time domain offsets is based at least in part on the time domain spacing and an MCS associated with data transmitted in the channel.

In an eighth aspect, alone or in combination with one or more of the first through seventh aspects, the configuration information further indicates a quantity of DMRS instances included in the TDRA, and a length of the TDRA is based at least in part on the first time domain offset, the second time domain offset, the time domain spacing, and the quantity of DMRS instances.

In a ninth aspect, alone or in combination with one or more of the first through eighth aspects, the configuration information further indicates a length of the TDRA, and a second quantity of DMRS instances included in the TDRA is based at least in part on the first time domain offset, the second time domain offset, the time domain spacing, and the length of the TDRA.

In a tenth aspect, alone or in combination with one or more of the first through ninth aspects, the time domain spacing parameter and the time domain offset parameter indicate a first quantity of DMRS instances to be included in the TDRA that is different from the second quantity of DMRS instances included in the TDRA, and the second quantity of DMRS instances included in the TDRA comprises at least one more DMRS instance than the first quantity of DMRS instances indicated by the time domain spacing parameter and the time domain offset parameter, based at least in part on a second time domain location of the last DMRS instance included in the first quantity of DMRS instances being associated with a time domain offset that is different from the set of second candidate time domain offsets.

In an eleventh aspect, alone or in combination with one or more of the first through tenth aspects, a first DMRS instance included in the TDRA is associated with a time domain offset of zero that is different from the first time domain offset based at least in part on the second quantity of DMRS instances included in the TDRA comprising the at least one more DMRS instance, and a uniform time gap occurs between each DMRS instance included in the second quantity of DMRS instances included in the TDRA.

In a twelfth aspect, alone or in combination with one or more of the first through eleventh aspects, process 700 includes receiving signaling indicating a set of candidate time domain spacing parameters, wherein the configuration information indicates the time domain spacing parameter from the set of candidate time domain spacing parameters, and wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the TDRA comprising the at least one more DMRS instance and the set of candidate time domain spacing parameters comprising at least one candidate time domain spacing parameter corresponding to the time gap that is less than the uniform time gap.

In a thirteenth aspect, alone or in combination with one or more of the first through twelfth aspects, process 700 includes receiving signaling indicating a set of candidate time domain spacing parameters, wherein the configuration information indicates the time domain spacing parameter that corresponds to a smallest time gap indicated by the set of candidate time domain spacing parameters, wherein a first DMRS instance included in the TDRA is associated with a time domain offset that is less than the first time domain offset based at least in part on the second quantity of DMRS instances included in the TDRA comprising the at least one more DMRS instance and the time domain spacing parameter corresponding to the smallest time gap indicated by the set of candidate time domain spacing parameters, and wherein a uniform time gap occurs between each DMRS instance included in the second quantity of DMRS instances included in the TDRA.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with DMRS pattern configurations.

As shown in FIG. 8, in some aspects, process 800 may include transmitting, to a UE, configuration information indicating, for a DMRS, a time domain spacing parameter and a time domain offset parameter (e.g., an initial time domain offset parameter), wherein the time domain offset parameter indicates a first time domain offset (e.g., an initial time domain offset) from a set of first candidate time domain offsets, and wherein the set of first candidate time domain offsets is based at least in part on a time domain spacing indicated by the time domain spacing parameter (block 810). For example, the network node (e.g., using transmission component 1004 and/or communication manager 1006, depicted in FIG. 10) may transmit, to a UE, the configuration information. In some aspects, the time domain offset parameter indicates a first time domain offset from a set of first candidate time domain offsets. In some aspects, the set of first candidate time domain offsets is based at least in part on a time domain spacing indicated by the time domain spacing parameter. In some cases, the set of first candidate time domain offsets may be limited (e.g., to a smaller set) based on the time domain spacing indicated by the time domain spacing parameter.

As further shown in FIG. 8, in some aspects, process 800 may include transmitting an SLIV indicating a TDRA associated with a channel (block 820). For example, the network node (e.g., using transmission component 1004 and/or communication manager 1006, depicted in FIG. 10) may transmit an SLIV indicating a TDRA associated with a channel, as described above. The SLIV may be a fluid SLIV. For example, the SLIV may indicate a TDRA that spans multiple slots or that is not limited to being contained within a single slot.

As further shown in FIG. 8, in some aspects, process 800 may include communicating, during the TDRA, one or more DMRSs associated with the channel at one or more respective time domain locations that are based at least in part on the SLIV, the time domain spacing, and the first time domain offset (block 830). For example, the network node (e.g., using reception component 1002, transmission component 1004, and/or communication manager 1006, depicted in FIG. 10) may communicate, during the TDRA, one or more DMRSs associated with the channel at one or more respective time domain locations that are based at least in part on the SLIV, the time domain spacing, and the first time domain offset, as described above. For example, the network node may transmit, and the UE may receive, one or more DMRSs within one or more DMRS symbols throughout the TDRA.

Process 800 may include additional aspects, such as any single aspect or any combination of aspects described below and/or in connection with one or more other processes described elsewhere herein.

In a first aspect, the configuration information comprises a single value indicative of both the time domain spacing parameter and the time domain offset parameter.

In a second aspect, alone or in combination with the first aspect, process 800 includes receiving, from the UE, capability information associated with a DMRS configuration, wherein the set of first candidate time domain offsets is further based at least in part on the capability information.

In a third aspect, alone or in combination with one or more of the first and second aspects, the capability information is based at least in part on a DMRS processing window size of the UE, a buffer capacity of the UE, a quantity of DMRS symbols that can be processed by the UE during a DMRS processing window, a quantity of time domain bases that are supported by the UE for channel estimation, or a time domain filtering capability of the UE for DMRS-based channel estimation.

In a fourth aspect, alone or in combination with one or more of the first through third aspects, the set of first candidate time domain offsets is further based at least in part on an MCS associated with data transmitted in the channel.

In a fifth aspect, alone or in combination with one or more of the first through fourth aspects, the time domain spacing corresponds to one or more time gaps that occur between each DMRS instance included in the TDRA.

In a sixth aspect, alone or in combination with one or more of the first through fifth aspects, the first time domain offset indicates a starting time domain location of a first DMRS instance included in the TDRA.

In a seventh aspect, alone or in combination with one or more of the first through sixth aspects, the respective time domain locations for communicating the one or more DMRSs are further based at least in part on a second time domain offset indicative of a time domain location of a last DMRS instance included in the TDRA, the second time domain offset is from a set of second candidate time domain offsets, and the set of second candidate time domain offsets is based at least in part on the time domain spacing and an MCS associated with data transmitted in the channel.

In an eighth aspect, alone or in combination with one or more of the first through seventh aspects, the configuration information further indicates a quantity of DMRS instances included in the TDRA, and a length of the TDRA is based at least in part on the first time domain offset, the second time domain offset, the time domain spacing, and the quantity of DMRS instances.

In a ninth aspect, alone or in combination with one or more of the first through eighth aspects, the configuration information further indicates a length of the TDRA, and a second quantity of DMRS instances included in the TDRA is based at least in part on the first time domain offset, the second time domain offset, the time domain spacing, and the length of the TDRA.

In a tenth aspect, alone or in combination with one or more of the first through ninth aspects, the time domain spacing parameter and the time domain offset parameter indicate a first quantity of DMRS instances to be included in the TDRA that is different from the second quantity of DMRS instances included in the TDRA, and the second quantity of DMRS instances included in the TDRA comprises at least one more DMRS instance than the first quantity of DMRS instances indicated by the time domain spacing parameter and the time domain offset parameter, based at least in part on a second time domain location of the last DMRS instance included in the first quantity of DMRS instances being associated with a time domain offset that is different from the set of second candidate time domain offsets.

In an eleventh aspect, alone or in combination with one or more of the first through tenth aspects, a first DMRS instance included in the TDRA is associated with a time domain offset of zero that is different from the first time domain offset based at least in part on the second quantity of DMRS instances included in the TDRA comprising the at least one more DMRS instance, and a uniform time gap occurs between each DMRS instance included in the second quantity of DMRS instances included in the TDRA.

In a twelfth aspect, alone or in combination with one or more of the first through eleventh aspects, process 800 includes transmitting signaling indicating a set of candidate time domain spacing parameters, wherein the configuration information indicates the time domain spacing parameter from the set of candidate time domain spacing parameters, and wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the TDRA comprising the at least one more DMRS instance and the set of candidate time domain spacing parameters comprising at least one candidate time domain spacing parameter corresponding to the time gap that is less than the uniform time gap.

In a thirteenth aspect, alone or in combination with one or more of the first through twelfth aspects, process 800 includes transmitting signaling indicating a set of candidate time domain spacing parameters, wherein the configuration information indicates the time domain spacing parameter that corresponds to a smallest time gap indicated by the set of candidate time domain spacing parameters, wherein a first DMRS instance included in the TDRA is associated with a time domain offset that is less than the first time domain offset based at least in part on the second quantity of DMRS instances included in the TDRA comprising the at least one more DMRS instance and the time domain spacing parameter corresponding to the smallest time gap indicated by the set of candidate time domain spacing parameters, and wherein a uniform time gap occurs between each DMRS instance included in the second quantity of DMRS instances included in the TDRA.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-6C. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter. The reception component 902 may receive an SLIV indicating a TDRA associated with a channel. The reception component 902 and/or the transmission component 904 may communicate, during the TDRA, one or more DMRSs associated with the channel at one or more respective time domain locations that are based at least in part on the SLIV, the time domain spacing, and the first time domain offset.

The transmission component 904 may transmit capability information associated with a DMRS configuration wherein the set of first candidate time domain offsets is further based at least in part on the capability information.

The reception component 902 may receive signaling indicating a set of candidate time domain spacing parameters, wherein the configuration information indicates the time domain spacing parameter from the set of candidate time domain spacing parameters, and wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the TDRA comprising the at least one more DMRS instance and the set of candidate time domain spacing parameters comprising at least one candidate time domain spacing parameter corresponding to the time gap that is less than the uniform time gap.

The reception component 902 may receive signaling indicating a set of candidate time domain spacing parameters, wherein the configuration information indicates the time domain spacing parameter that corresponds to a smallest time gap indicated by the set of candidate time domain spacing parameters, wherein a first DMRS instance included in the TDRA is associated with a time domain offset that is less than the first time domain offset based at least in part on the second quantity of DMRS instances included in the TDRA comprising the at least one more DMRS instance and the time domain spacing parameter corresponding to the smallest time gap indicated by the set of candidate time domain spacing parameters, and wherein a uniform time gap occurs between each DMRS instance included in the second quantity of DMRS instances included in the TDRA.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3-6C. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit, to a UE, configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter. The transmission component 1004 may transmit an SLIV indicating a TDRA associated with a channel. The reception component 1002 and/or the transmission component 1004 may communicate, during the TDRA, one or more DMRSs associated with the channel at one or more respective time domain locations that are based at least in part on the SLIV, the time domain spacing, and the first time domain offset.

The reception component 1002 may receive, from the UE, capability information associated with a DMRS configuration wherein the set of first candidate time domain offsets is further based at least in part on the capability information.

The transmission component 1004 may transmit signaling indicating a set of candidate time domain spacing parameters, wherein the configuration information indicates the time domain spacing parameter from the set of candidate time domain spacing parameters, and wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the TDRA comprising the at least one more DMRS instance and the set of candidate time domain spacing parameters comprising at least one candidate time domain spacing parameter corresponding to the time gap that is less than the uniform time gap.

The transmission component 1004 may transmit signaling indicating a set of candidate time domain spacing parameters, wherein the configuration information indicates the time domain spacing parameter that corresponds to a smallest time gap indicated by the set of candidate time domain spacing parameters, wherein a first DMRS instance included in the TDRA is associated with a time domain offset that is less than the first time domain offset based at least in part on the second quantity of DMRS instances included in the TDRA comprising the at least one more DMRS instance and the time domain spacing parameter corresponding to the smallest time gap indicated by the set of candidate time domain spacing parameters, and wherein a uniform time gap occurs between each DMRS instance included in the second quantity of DMRS instances included in the TDRA.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter; receiving an SLIV indicating a TDRA associated with a channel; and communicating, during the TDRA, one or more DMRSs associated with the channel at one or more respective time domain locations that are based at least in part on the SLIV, the time domain spacing, and the first time domain offset.

Aspect 2: The method of Aspect 1, wherein the configuration information comprises a single value indicative of both the time domain spacing parameter and the time domain offset parameter.

Aspect 3: The method of any of Aspects 1-2, further comprising: transmitting capability information associated with a DMRS configuration, wherein the set of first candidate time domain offsets is further based at least in part on the capability information.

Aspect 4: The method of Aspect 3, wherein the capability information is based at least in part on: a DMRS processing window size of the UE, a buffer capacity of the UE, a quantity of DMRS symbols that can be processed by the UE during a DMRS processing window, a quantity of time domain bases that are supported by the UE for channel estimation, or a time domain filtering capability of the UE for DMRS-based channel estimation.

Aspect 5: The method of any of Aspects 1-4, wherein the set of first candidate time domain offsets is further based at least in part on an MCS associated with data transmitted in the channel.

Aspect 6: The method of any of Aspects 1-5, wherein the time domain spacing corresponds to one or more time gaps that occur between each DMRS instance included in the TDRA.

Aspect 7: The method of any of Aspects 1-6, wherein the first time domain offset indicates a starting time domain location of a first DMRS instance included in the TDRA.

Aspect 8: The method of any of Aspects 1-7, wherein: the respective time domain locations for communicating the one or more DMRSs are further based at least in part on a second time domain offset indicative of a time domain location of a last DMRS instance included in the TDRA, the second time domain offset is from a set of second candidate time domain offsets, and the set of second candidate time domain offsets is based at least in part on the time domain spacing and an MCS associated with data transmitted in the channel.

Aspect 9: The method of Aspect 8, wherein: the configuration information further indicates a quantity of DMRS instances included in the TDRA, and a length of the TDRA is based at least in part on the first time domain offset, the second time domain offset, the time domain spacing, and the quantity of DMRS instances.

Aspect 10: The method of Aspect 8, wherein: the configuration information further indicates a length of the TDRA, and a second quantity of DMRS instances included in the TDRA is based at least in part on the first time domain offset, the second time domain offset, the time domain spacing, and the length of the TDRA.

Aspect 11: The method of Aspect 10, wherein: the time domain spacing parameter and the time domain offset parameter indicate a first quantity of DMRS instances to be included in the TDRA that is different from the second quantity of DMRS instances included in the TDRA, and the second quantity of DMRS instances included in the TDRA comprises at least one more DMRS instance than the first quantity of DMRS instances indicated by the time domain spacing parameter and the time domain offset parameter, based at least in part on a second time domain location of the last DMRS instance included in the first quantity of DMRS instances being associated with a time domain offset that is different from the set of second candidate time domain offsets.

Aspect 12: The method of Aspect 11, wherein: a first DMRS instance included in the TDRA is associated with a time domain offset of zero that is different from the first time domain offset based at least in part on the second quantity of DMRS instances included in the TDRA comprising the at least one more DMRS instance, and a uniform time gap occurs between each DMRS instance included in the second quantity of DMRS instances included in the TDRA.

Aspect 13: The method of Aspect 11, further comprising: receiving signaling indicating a set of candidate time domain spacing parameters, wherein the configuration information indicates the time domain spacing parameter from the set of candidate time domain spacing parameters, and wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the TDRA comprising the at least one more DMRS instance and the set of candidate time domain spacing parameters comprising at least one candidate time domain spacing parameter corresponding to the time gap that is less than the uniform time gap.

Aspect 14: The method of Aspect 11, further comprising: receiving signaling indicating a set of candidate time domain spacing parameters, wherein the configuration information indicates the time domain spacing parameter that corresponds to a smallest time gap indicated by the set of candidate time domain spacing parameters, wherein a first DMRS instance included in the TDRA is associated with a time domain offset that is less than the first time domain offset based at least in part on the second quantity of DMRS instances included in the TDRA comprising the at least one more DMRS instance and the time domain spacing parameter corresponding to the smallest time gap indicated by the set of candidate time domain spacing parameters, and wherein a uniform time gap occurs between each DMRS instance included in the second quantity of DMRS instances included in the TDRA.

Aspect 15: A method of wireless communication performed by a network node, comprising: transmitting, to a UE, configuration information indicating, for a DMRS, a time domain spacing parameter and a time domain offset parameter, wherein the time domain offset parameter indicates a first time domain offset from a set of first candidate time domain offsets, and wherein the set of first candidate time domain offsets is based at least in part on a time domain spacing indicated by the time domain spacing parameter; transmitting an SLIV indicating a TDRA associated with a channel; and communicating, during the TDRA, one or more DMRSs associated with the channel at one or more respective time domain locations that are based at least in part on the SLIV, the time domain spacing, and the first time domain offset.

Aspect 16: The method of Aspect 15, wherein the configuration information comprises a single value indicative of both the time domain spacing parameter and the time domain offset parameter.

Aspect 17: The method of any of Aspects 15-16, further comprising: receiving, from the UE, capability information associated with a DMRS configuration, wherein the set of first candidate time domain offsets is further based at least in part on the capability information.

Aspect 18: The method of Aspect 17, wherein the capability information is based at least in part on: a DMRS processing window size of the UE, a buffer capacity of the UE, a quantity of DMRS symbols that can be processed by the UE during a DMRS processing window, a quantity of time domain bases that are supported by the UE for channel estimation, or a time domain filtering capability of the UE for DMRS-based channel estimation.

Aspect 19: The method of any of Aspects 15-18, wherein the set of first candidate time domain offsets is further based at least in part on an MCS associated with data transmitted in the channel.

Aspect 20: The method of any of Aspects 15-19, wherein the time domain spacing corresponds to one or more time gaps that occur between each DMRS instance included in the TDRA.

Aspect 21: The method of any of Aspects 15-20, wherein the first time domain offset indicates a starting time domain location of a first DMRS instance included in the TDRA.

Aspect 22: The method of any of Aspects 15-21, wherein: the respective time domain locations for communicating the one or more DMRSs are further based at least in part on a second time domain offset indicative of a time domain location of a last DMRS instance included in the TDRA, the second time domain offset is from a set of second candidate time domain offsets, and the set of second candidate time domain offsets is based at least in part on the time domain spacing and an MCS associated with data transmitted in the channel.

Aspect 23: The method of Aspect 22, wherein: the configuration information further indicates a quantity of DMRS instances included in the TDRA, and a length of the TDRA is based at least in part on the first time domain offset, the second time domain offset, the time domain spacing, and the quantity of DMRS instances.

Aspect 24: The method of Aspect 22, wherein: the configuration information further indicates a length of the TDRA, and a second quantity of DMRS instances included in the TDRA is based at least in part on the first time domain offset, the second time domain offset, the time domain spacing, and the length of the TDRA.

Aspect 25: The method of Aspect 24, wherein: the time domain spacing parameter and the time domain offset parameter indicate a first quantity of DMRS instances to be included in the TDRA that is different from the second quantity of DMRS instances included in the TDRA, and the second quantity of DMRS instances included in the TDRA comprises at least one more DMRS instance than the first quantity of DMRS instances indicated by the time domain spacing parameter and the time domain offset parameter, based at least in part on a second time domain location of the last DMRS instance included in the first quantity of DMRS instances being associated with a time domain offset that is different from the set of second candidate time domain offsets.

Aspect 26: The method of Aspect 25, wherein: a first DMRS instance included in the TDRA is associated with a time domain offset of zero that is different from the first time domain offset based at least in part on the second quantity of DMRS instances included in the TDRA comprising the at least one more DMRS instance, and a uniform time gap occurs between each DMRS instance included in the second quantity of DMRS instances included in the TDRA.

Aspect 27: The method of Aspect 25, further comprising: transmitting signaling indicating a set of candidate time domain spacing parameters, wherein the configuration information indicates the time domain spacing parameter from the set of candidate time domain spacing parameters, and wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the TDRA comprising the at least one more DMRS instance and the set of candidate time domain spacing parameters comprising at least one candidate time domain spacing parameter corresponding to the time gap that is less than the uniform time gap.

Aspect 28: The method of Aspect 25, further comprising: transmitting signaling indicating a set of candidate time domain spacing parameters, wherein the configuration information indicates the time domain spacing parameter that corresponds to a smallest time gap indicated by the set of candidate time domain spacing parameters, wherein a first DMRS instance included in the TDRA is associated with a time domain offset that is less than the first time domain offset based at least in part on the second quantity of DMRS instances included in the TDRA comprising the at least one more DMRS instance and the time domain spacing parameter corresponding to the smallest time gap indicated by the set of candidate time domain spacing parameters, and wherein a uniform time gap occurs between each DMRS instance included in the second quantity of DMRS instances included in the TDRA.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive configuration information indicating, for a demodulation reference signal (DMRS), a time domain spacing parameter and a time domain offset parameter,
wherein the time domain offset parameter indicates a first time domain offset from a set of first candidate time domain offsets, and
wherein the set of first candidate time domain offsets is based at least in part on a time domain spacing indicated by the time domain spacing parameter;
receive a start and length indicator value (SLIV) indicating a time domain resource allocation associated with a channel; and
communicate, during the time domain resource allocation, one or more DMRSs associated with the channel at one or more respective time domain locations that are based at least in part on the SLIV, the time domain spacing, and the first time domain offset.

2. The apparatus of claim 1, wherein the configuration information comprises a single value indicative of both the time domain spacing parameter and the time domain offset parameter.

3. The apparatus of claim 1, wherein the one or more processors are further configured to cause the UE to:
transmit capability information associated with a DMRS configuration,
wherein the set of first candidate time domain offsets is further based at least in part on the capability information.

4. The apparatus of claim 3, wherein the capability information is based at least in part on:
a DMRS processing window size of the UE,
a buffer capacity of the UE,
a quantity of DMRS symbols that can be processed by the UE during a DMRS processing window,
a quantity of time domain bases that are supported by the UE for channel estimation, or
a time domain filtering capability of the UE for DMRS-based channel estimation.

5. The apparatus of claim 1, wherein the set of first candidate time domain offsets is further based at least in part on a modulation and coding scheme (MCS) associated with data transmitted in the channel.

6. The apparatus of claim 1, wherein the time domain spacing corresponds to one or more time gaps that occur between each DMRS instance included in the time domain resource allocation.

7. The apparatus of claim 1, wherein the first time domain offset indicates a starting time domain location of a first DMRS instance included in the time domain resource allocation.

8. The apparatus of claim 1, wherein:
the respective time domain locations for communicating the one or more DMRSs are further based at least in part on a second time domain offset indicative of a time domain location of a last DMRS instance included in the time domain resource allocation,
the second time domain offset is from a set of second candidate time domain offsets, and
the set of second candidate time domain offsets is based at least in part on the time domain spacing and an MCS associated with data transmitted in the channel.

9. The apparatus of claim 8, wherein:
the configuration information further indicates a quantity of DMRS instances included in the time domain resource allocation, and
a length of the time domain resource allocation is based at least in part on the first time domain offset, the second time domain offset, the time domain spacing, and the quantity of DMRS instances.

10. The apparatus of claim 8, wherein:
the configuration information further indicates a length of the time domain resource allocation, and
a second quantity of DMRS instances included in the time domain resource allocation is based at least in part on the first time domain offset, the second time domain offset, the time domain spacing, and the length of the time domain resource allocation.

11. The apparatus of claim 10, wherein:
the time domain spacing parameter and the time domain offset parameter indicate a first quantity of DMRS instances to be included in the time domain resource allocation that is different from the second quantity of DMRS instances included in the time domain resource allocation, and
the second quantity of DMRS instances included in the time domain resource allocation comprises at least one more DMRS instance than the first quantity of DMRS instances indicated by the time domain spacing parameter and the time domain offset parameter, based at least in part on a second time domain location of the last DMRS instance included in the first quantity of DMRS instances being associated with a time domain offset that is different from the set of second candidate time domain offsets.

12. The apparatus of claim 11, wherein:
a first DMRS instance included in the time domain resource allocation is associated with a time domain offset of zero that is different from the first time domain offset based at least in part on the second quantity of DMRS instances included in the time domain resource allocation comprising the at least one more DMRS instance, and
a uniform time gap occurs between each DMRS instance included in the second quantity of DMRS instances included in the time domain resource allocation.

13. The apparatus of claim 11, wherein the one or more processors are further configured to cause the UE to:
receive signaling indicating a set of candidate time domain spacing parameters,
wherein the configuration information indicates the time domain spacing parameter from the set of candidate time domain spacing parameters, and
wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the time domain resource allocation comprising the at least one more DMRS instance and the set of candidate time domain spacing parameters comprising at least one candidate time domain spacing parameter corresponding to the time gap that is less than the uniform time gap.

14. The apparatus of claim 11, wherein the one or more processors are further configured to cause the UE to:
receive signaling indicating a set of candidate time domain spacing parameters,
wherein the configuration information indicates the time domain spacing parameter that corresponds to a smallest time gap indicated by the set of candidate time domain spacing parameters,
wherein a first DMRS instance included in the time domain resource allocation is associated with a time domain offset that is less than the first time domain offset based at least in part on the second quantity of DMRS instances included in the time domain resource allocation comprising the at least one more DMRS instance and the time domain spacing parameter corresponding to the smallest time gap indicated by the set of candidate time domain spacing parameters, and
wherein a uniform time gap occurs between each DMRS instance included in the second quantity of DMRS instances included in the time domain resource allocation.

15. An apparatus for wireless communication at a network node, comprising:
one or more memories; and
one or more processors, coupled to the one or more memories, configured to cause the network node to:
transmit, to a user equipment (UE), configuration information indicating, for a demodulation reference signal (DMRS), a time domain spacing parameter and a time domain offset parameter,
wherein the time domain offset parameter indicates a first time domain offset from a set of first candidate time domain offsets, and
wherein the set of first candidate time domain offsets is based at least in part on a time domain spacing indicated by the time domain spacing parameter;
transmit a start and length indicator value (SLIV) indicating a time domain resource allocation associated with a channel; and
communicate, during the time domain resource allocation, one or more DMRSs associated with the channel at one or more respective time domain locations that are based at least in part on the SLIV, the time domain spacing, and the first time domain offset.

16. The apparatus of claim 15, wherein the configuration information comprises a single value indicative of both the time domain spacing parameter and the time domain offset parameter.

17. The apparatus of claim 15, wherein the one or more processors are further configured to cause the network node to:
receive, from the UE, capability information associated with a DMRS configuration,
wherein the set of first candidate time domain offsets is further based at least in part on the capability information.

18. The apparatus of claim 17, wherein the capability information is based at least in part on:
a DMRS processing window size of the UE,
a buffer capacity of the UE,
a quantity of DMRS symbols that can be processed by the UE during a DMRS processing window,
a quantity of time domain bases that are supported by the UE for channel estimation, or
a time domain filtering capability of the UE for DMRS-based channel estimation.

19. The apparatus of claim 15, wherein the set of first candidate time domain offsets is further based at least in part on a modulation and coding scheme (MCS) associated with data transmitted in the channel.

20. The apparatus of claim 15, wherein the time domain spacing corresponds to one or more time gaps that occur between each DMRS instance included in the time domain resource allocation.

21. The apparatus of claim 15, wherein the first time domain offset indicates a starting time domain location of a first DMRS instance included in the time domain resource allocation.

22. The apparatus of claim 15, wherein:
the respective time domain locations for communicating the one or more DMRSs are further based at least in part on a second time domain offset indicative of a time domain location of a last DMRS instance included in the time domain resource allocation,
the second time domain offset is from a set of second candidate time domain offsets, and
the set of second candidate time domain offsets is based at least in part on the time domain spacing and an MCS associated with data transmitted in the channel.

23. The apparatus of claim 22, wherein:
the configuration information further indicates a quantity of DMRS instances included in the time domain resource allocation, and
a length of the time domain resource allocation is based at least in part on the first time domain offset, the second time domain offset, the time domain spacing, and the quantity of DMRS instances.

24. The apparatus of claim 22, wherein:
the configuration information further indicates a length of the time domain resource allocation, and
a second quantity of DMRS instances included in the time domain resource allocation is based at least in part on the first time domain offset, the second time domain offset, the time domain spacing, and the length of the time domain resource allocation.

25. The apparatus of claim 24, wherein:
the time domain spacing parameter and the time domain offset parameter indicate a first quantity of DMRS instances to be included in the time domain resource allocation that is different from the second quantity of DMRS instances included in the time domain resource allocation, and
the second quantity of DMRS instances included in the time domain resource allocation comprises at least one more DMRS instance than the first quantity of DMRS instances indicated by the time domain spacing parameter and the time domain offset parameter, based at least in part on a second time domain location of the last DMRS instance included in the first quantity of DMRS instances being associated with a time domain offset that is different from the set of second candidate time domain offsets.

26. The apparatus of claim 25, wherein:
a first DMRS instance included in the time domain resource allocation is associated with a time domain offset of zero that is different from the first time domain offset based at least in part on the second quantity of DMRS instances included in the time domain resource allocation comprising the at least one more DMRS instance, and
a uniform time gap occurs between each DMRS instance included in the second quantity of DMRS instances included in the time domain resource allocation.

27. The apparatus of claim 25, wherein the one or more processors are further configured to cause the network node to:
transmit signaling indicating a set of candidate time domain spacing parameters,
wherein the configuration information indicates the time domain spacing parameter from the set of candidate time domain spacing parameters, and
wherein a time gap that occurs between the last DMRS instance and a second DMRS instance that occurs immediately prior to the last DMRS instance is less than a uniform time gap indicated by the time domain spacing parameter, based at least in part on the second quantity of DMRS instances included in the time domain resource allocation comprising the at least one more DMRS instance and the set of candidate time domain spacing parameters comprising at least one candidate time domain spacing parameter corresponding to the time gap that is less than the uniform time gap.

28. The apparatus of claim 25, wherein the one or more processors are further configured to cause the network node to:
transmit signaling indicating a set of candidate time domain spacing parameters,
wherein the configuration information indicates the time domain spacing parameter that corresponds to a smallest time gap indicated by the set of candidate time domain spacing parameters,
wherein a first DMRS instance included in the time domain resource allocation is associated with a time domain offset that is less than the first time domain offset based at least in part on the second quantity of DMRS instances included in the time domain resource allocation comprising the at least one more DMRS instance and the time domain spacing parameter corresponding to the smallest time gap indicated by the set of candidate time domain spacing parameters, and
wherein a uniform time gap occurs between each DMRS instance included in the second quantity of DMRS instances included in the time domain resource allocation.

29. A method of wireless communication performed by a user equipment (UE), comprising:
receiving configuration information indicating, for a demodulation reference signal (DMRS), a time domain spacing parameter and a time domain offset parameter,
wherein the time domain offset parameter indicates a first time domain offset from a set of first candidate time domain offsets, and
wherein the set of first candidate time domain offsets is based at least in part on a time domain spacing indicated by the time domain spacing parameter;
receiving a start and length indicator value (SLIV) indicating a time domain resource allocation associated with a channel; and
communicating, during the time domain resource allocation, one or more DMRSs associated with the channel at one or more respective time domain locations that are based at least in part on the SLIV, the time domain spacing, and the first time domain offset.

30. A method of wireless communication performed by a network node, comprising:
transmitting, to a user equipment (UE), configuration information indicating, for a demodulation reference signal (DMRS), a time domain spacing parameter and a time domain offset parameter,
wherein the time domain offset parameter indicates a first time domain offset from a set of first candidate time domain offsets, and
wherein the set of first candidate time domain offsets is based at least in part on a time domain spacing indicated by the time domain spacing parameter;
transmitting a start and length indicator value (SLIV) indicating a time domain resource allocation associated with a channel; and
communicating, during the time domain resource allocation, one or more DMRSs associated with the channel at one or more respective time domain locations that are based at least in part on the SLIV, the time domain spacing, and the first time domain offset.
